(19) United States
(12) Patent Application Publication
(10) Pub. No.: US 2026/0353357 A1
(43) Pub. Date: Nov. 5, 2026

(54) MULTI-PORT COMMUNICATIONS FOR DOWNLINK BROADCAST SIGNALING

(71) Applicant: QUALCOMM Incorporated, San Diego, CA (US)

(72) Inventors: Xiaoxia ZHANG, San Diego, CA (US); Junyi LI, Greentown, PA (US); Tao LUO, San Diego, CA (US); Jianghong LUO, Skillman, NJ (US); Navid ABEDINI, Basking Ridge, NJ (US)

(21) Appl. No.: 19/199,145

(22) Filed: May 5, 2025

(51) Int. Cl. H04W 68/02; H04W 48/14

(52) U.S. Cl. CPC H04W 68/02; H04W 48/14

(57) ABSTRACT

This disclosure provides methods, components, devices and systems for multi-port communications for downlink broadcast signaling. A user equipment (UE) may transmit or receive one or more signals that enable multi-port downlink broadcast signal communications. Thus, the UE may receive, via a first port of multiple ports of the UE and based on enablement of the multi-port downlink broadcast signal communications, a first downlink broadcast signal from a network entity. Additionally, the UE may receive, via a second port of the multiple ports and based on enablement of the multi-port downlink broadcast signal communications, a second downlink broadcast signal from the network entity, where the first port is different from the second port. In such cases, the first downlink broadcast signal and the second downlink broadcast signal may be received prior to reception, from the network entity, of a radio resource control message that indicates first configuration information for the UE.

### INTRODUCTION

This disclosure relates generally to wireless communication, and more specifically to systems, devices, methods, and techniques associated with multi-port communications.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communication by a UE is described. The method may include participating in communication of one or more signals that enable multi-port downlink broadcast signal communications, receiving, via a first port of a set of multiple ports of the UE and based on enablement of the multi-port downlink broadcast signal communications, a first downlink broadcast signal from a network entity, and receiving, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of a radio resource control (RRC) message that indicates first configuration information for the UE.

An apparatus for wireless communication at a UE is described. The apparatus may include one or more memories and one or more processors coupled with the one or more memories. The one or more processors may be configured to cause the UE to participate in communication of one or more signals that enable multi-port downlink broadcast signal communications, receive, via a first port of a set of multiple ports of the UE and based on enablement of the multi-port downlink broadcast signal communications, a first downlink broadcast signal from a network entity, and receive, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of an RRC message that indicates first configuration information for the UE.

Another apparatus for wireless communication at a UE is described. The apparatus may include means for participating in communication of one or more signals that enable multi-port downlink broadcast signal communications, means for receiving, via a first port of a set of multiple ports of the UE and based on enablement of the multi-port downlink broadcast signal communications, a first downlink broadcast signal from a network entity, and means for receiving, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of an RRC message that indicates first configuration information for the UE.

A non-transitory computer-readable medium storing code for wireless communication is described. The code may include instructions executable by one or more processors to participate in communication of one or more signals that enable multi-port downlink broadcast signal communications, receive, via a first port of a set of multiple ports of the UE and based on enablement of the multi-port downlink broadcast signal communications, a first downlink broadcast signal from a network entity, and receive, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of an RRC message that indicates first configuration information for the UE.

In some examples of the method, apparatus, and non-transitory computer-readable medium described herein, the first downlink broadcast signal includes a first paging message.

In some examples of the method, apparatus, and non-transitory computer-readable medium described herein, the second downlink broadcast signal includes a downlink reference signal or a second paging message.

In some examples of the method, apparatus, and non-transitory computer-readable medium described herein, participating in communication of the one or more signals that enable the multi-port downlink broadcast signal communications may include operations, features, means, or instructions for receiving second configuration information indicative of a paging type of a paging occasion (PO), where the paging type may be indicative of multi-port paging.

In some examples of the method, apparatus, and non-transitory computer-readable medium described herein, the first downlink broadcast signal and the second downlink broadcast signal may be received via different ports during the PO in accordance with the paging type.

In some examples of the method, apparatus, and non-transitory computer-readable medium described herein, participating in communication of the one or more signals that enable the multi-port downlink broadcast signal communications may include operations, features, means, or instructions for receiving a control message associated with the first paging message, where the control message indicates a paging type of the first paging message.

In some examples of the method, apparatus, and non-transitory computer-readable medium described herein, the paging type may be indicative of multi-port paging.

In some examples of the method, apparatus, and non-transitory computer-readable medium described herein, the first downlink broadcast signal and the second downlink broadcast signal may be received via different ports in accordance with the paging type.

In some examples of the method, apparatus, and non-transitory computer-readable medium described herein, participating in communication of the one or more signals that enable the multi-port downlink broadcast signal communications may include operations, features, means, or instructions for receiving a paging early indication for the first paging message, where the paging early indication (PEI) indicates a paging type of the first paging message.

In some examples of the method, apparatus, and non-transitory computer-readable medium described herein, the paging type may be indicative of multi-port paging.

In some examples of the method, apparatus, and non-transitory computer-readable medium described herein, the first downlink broadcast signal and the second downlink broadcast signal may be received via different ports in accordance with the paging type.

In some examples of the method, apparatus, and non-transitory computer-readable medium described herein, multi-rank uplink transmissions may be enabled during a random access procedure in accordance with enablement of the multi-port downlink broadcast signal communications and based on the second downlink broadcast signal including a downlink reference signal.

In some examples of the method, apparatus, and non-transitory computer-readable medium described herein, the first paging message may be associated with one or more first symbols in a downlink control channel and one or more second symbols in a downlink shared channel.

In some examples of the method, apparatus, and non-transitory computer-readable medium described herein, the first paging message may be received via the one or more first symbols in the downlink control channel.

In some examples of the method, apparatus, and non-transitory computer-readable medium described herein, the second downlink broadcast signal includes a downlink reference signal received via the one or more second symbols in the downlink shared channel.

In some examples of the method, apparatus, and non-transitory computer-readable medium described herein, the first paging message includes a first portion of a paging data message and the second downlink broadcast signal includes a second paging message that further includes a second portion of the paging data message.

In some examples of the method, apparatus, and non-transitory computer-readable medium described herein, the first downlink broadcast signal includes a first system information block (SIB) message.

In some examples of the method, apparatus, and non-transitory computer-readable medium described herein, the second downlink broadcast signal includes a second SIB message or a downlink reference signal.

In some examples of the method, apparatus, and non-transitory computer-readable medium described herein, participating in communication of the one or more signals that enable the multi-port downlink broadcast signal communications may include operations, features, means, or instructions for receiving configuration information that indicates on-demand SIB messages may be associated with multi-port communications and indicates periodic SIB messages may be associated with single-port communications.

In some examples of the method, apparatus, and non-transitory computer-readable medium described herein, the first SIB message may be a first on-demand SIB message.

In some examples of the method, apparatus, and non-transitory computer-readable medium described herein, the first downlink broadcast signal and the second downlink broadcast signal may be received via different ports in accordance with the first on-demand SIB message.

In some examples of the method, apparatus, and non-transitory computer-readable medium described herein, participating in communication of the one or more signals that enable the multi-port downlink broadcast signal communications may include operations, features, means, or instructions for receiving a control message that schedules the first SIB message, where the control message indicates a SIB transmission type of the first SIB message.

In some examples of the method, apparatus, and non-transitory computer-readable medium described herein, the SIB transmission type may be indicative of multi-port communications.

In some examples of the method, apparatus, and non-transitory computer-readable medium described herein, the first downlink broadcast signal and the second downlink broadcast signal may be received via different ports in accordance with the SIB transmission type.

In some examples of the method, apparatus, and non-transitory computer-readable medium described herein, participating in communication of the one or more signals that enable the multi-port downlink broadcast signal communications may include operations, features, means, or instructions for transmitting a request message indicative of a SIB transmission type for the first SIB message.

In some examples of the method, apparatus, and non-transitory computer-readable medium described herein, the requested SIB transmission type may be indicative of multi-port communications.

In some examples of the method, apparatus, and non-transitory computer-readable medium described herein, the first downlink broadcast signal and the second downlink broadcast signal may be received via different ports in accordance with the requested SIB transmission type.

In some examples of the method, apparatus, and non-transitory computer-readable medium described herein, the request message includes an uplink wake-up signal (WUS).

In some examples of the method, apparatus, and non-transitory computer-readable medium described herein, the first SIB message includes control information and the second downlink broadcast signal includes a second SIB message that further includes data associated with the first SIB message.

In some examples of the method, apparatus, and non-transitory computer-readable medium described herein, the first downlink broadcast signal includes a downlink message of a random access (RA) procedure.

In some examples of the method, apparatus, and non-transitory computer-readable medium described herein, the second downlink broadcast signal includes a downlink reference signal or a downlink data message associated with the downlink message of the RA procedure.

In some examples of the method, apparatus, and non-transitory computer-readable medium described herein, participating in communication of the one or more signals that enable the multi-port downlink broadcast signal communications may include operations, features, means, or instructions for transmitting a first uplink message of the random access procedure via a first set of resources, where the first set of resources corresponds to a first type of RA s procedure from a set of multiple types of RA procedures.

In some examples of the method, apparatus, and non-transitory computer-readable medium described herein, the first type of RA procedure enables multi-port communications.

In some examples of the method, apparatus, and non-transitory computer-readable medium described herein, the first downlink message of the random access procedure and the second downlink broadcast signal may be received via different ports in accordance with enablement of multi-port communications based on the first type of RA procedure.

In some examples of the method, apparatus, and non-transitory computer-readable medium described herein, participating in communication of the one or more signals that enable the multi-port downlink broadcast signal communications may include operations, features, means, or instructions for receiving a control message associated with the first downlink message of the RA procedure, where the control message indicates a transmission type of the first downlink message of the RA procedure.

In some examples of the method, apparatus, and non-transitory computer-readable medium described herein, the transmission type may be indicative of multi-port communications.

In some examples of the method, apparatus, and non-transitory computer-readable medium described herein, the first downlink message of the random access procedure and the second downlink broadcast signal may be received via different ports in accordance with the transmission type.

In some examples of the method, apparatus, and non-transitory computer-readable medium described herein, the downlink message includes a first downlink message of the random access procedure and the method, apparatuses, and non-transitory computer-readable medium may include further operations, features, means, or instructions for transmitting, via a second uplink message of the RA procedure, a report indicative of a rank indicator, a precoding matrix indicator (PMI), or both, in response to reception of the first downlink message of the RA procedure and the second downlink broadcast signal via different ports.

In some examples of the method, apparatus, and non-transitory computer-readable medium described herein, the downlink message includes a second downlink message of the random access procedure and the method, apparatuses, and non-transitory computer-readable medium may include further operations, features, means, or instructions for transmitting, via a feedback message in response to the second downlink message of the random access procedure or via another uplink message, a report indicative of a rank indicator, a PMI, or both, in response to reception of the second downlink message of the RA procedure and the second downlink broadcast signal via different ports.

In some examples of the method, apparatus, and non-transitory computer-readable medium described herein, the first downlink broadcast signal includes a demodulation reference signal (DMRS) and the second downlink broadcast signal includes another downlink reference signal.

In some examples of the method, apparatus, and non-transitory computer-readable medium described herein, the DMRS and the downlink reference signal may be received via a same set of resources in a time domain or a same set of resources in a frequency domain.

In some examples of the method, apparatus, and non-transitory computer-readable medium described herein, the DMRS may be associated with a first power offset relative to a synchronization signal block (SSB).

In some examples of the method, apparatus, and non-transitory computer-readable medium described herein, the downlink reference signal may be associated with a second power offset relative to the SSB, the second power offset different from the first power offset.

In some examples, the apparatus may further include one or more antennas configured to receive the first downlink broadcast signal via the first port and to receive the second downlink broadcast signal via the second port.

A method for wireless communications by a network entity is described. The method may include participating in communication of one or more signals that enable multi-port downlink broadcast signal communications, outputting, based on enablement of the multi-port downlink broadcast signal communications, a first downlink broadcast signal for a UE, and outputting, based on enablement of the multi-port downlink broadcast signal communications, a second downlink broadcast signal for the UE, where the first downlink broadcast signal and the second downlink broadcast signal are obtained prior to output, for the UE, of an RRC message indicative of first configuration information for the UE.

An apparatus for wireless communications at a network entity is described. The network entity may include one or more memories and one or more processors coupled with the one or more memories. The one or more processors may be configured to cause the network entity to participate in communication of one or more signals that enable multi-port downlink broadcast signal communications, output, based on enablement of the multi-port downlink broadcast signal communications, a first downlink broadcast signal for a UE, and output, based on enablement of the multi-port downlink broadcast signal communications, a second downlink broadcast signal for the UE, where the first downlink broadcast signal and the second downlink broadcast signal are obtained prior to output, for the UE, of an RRC message indicative of first configuration information for the UE.

Another apparatus for wireless communications at a network entity is described. The apparatus may include means for participating in communication of one or more signals that enable multi-port downlink broadcast signal communications, means for outputting, based on enablement of the multi-port downlink broadcast signal communications, a first downlink broadcast signal for a UE, and means for outputting, based on enablement of the multi-port downlink broadcast signal communications, a second downlink broadcast signal for the UE, where the first downlink broadcast signal and the second downlink broadcast signal are obtained prior to output, for the UE, of an RRC message indicative of first configuration information for the UE.

A non-transitory computer-readable medium storing code for wireless communications is described. The code may include instructions executable by one or more processors to participate in communication of one or more signals that enable multi-port downlink broadcast signal communications, output, based on enablement of the multi-port downlink broadcast signal communications, a first downlink broadcast signal for a UE, and output, based on enablement of the multi-port downlink broadcast signal communications, a second downlink broadcast signal for the UE, where the first downlink broadcast signal and the second downlink broadcast signal are obtained prior to output, for the UE, of a radio resource control message indicative of first configuration information for the UE.

In some examples of the method, apparatus, and non-transitory computer-readable medium described herein, the first downlink broadcast signal includes a first paging message.

In some examples of the method, apparatus, and non-transitory computer-readable medium described herein, the second downlink broadcast signal includes a downlink reference signal or a second paging message.

In some examples of the method, apparatus, and non-transitory computer-readable medium described herein, participating in communication of the one or more signals that enable the multi-port downlink broadcast signal communications may include operations, features, means, or instructions for outputting second configuration information indicative of a paging type of a PO.

In some examples of the method, apparatus, and non-transitory computer-readable medium described herein, the paging type may be indicative of multi-port paging.

In some examples of the method, apparatus, and non-transitory computer-readable medium described herein, the multi-port downlink broadcast signal communications may be enabled in accordance with the paging type.

In some examples of the method, apparatus, and non-transitory computer-readable medium described herein, participating in communication of the one or more signals that enable the multi-port downlink broadcast signal communications may include operations, features, means, or instructions for outputting a control message associated with the first paging message, where the control message indicates a paging type of the first paging message.

In some examples of the method, apparatus, and non-transitory computer-readable medium described herein, the paging type may be indicative of multi-port paging.

In some examples of the method, apparatus, and non-transitory computer-readable medium described herein, the multi-port downlink broadcast signal communications may be enabled in accordance with the paging type.

In some examples of the method, apparatus, and non-transitory computer-readable medium described herein, participating in communication of the one or more signals that enable the multi-port downlink broadcast signal communications may include operations, features, means, or instructions for outputting a PEI for the first paging message, where the PEI indicates a paging type of the first paging message.

In some examples of the method, apparatus, and non-transitory computer-readable medium described herein, the paging type may be indicative of multi-port paging.

In some examples of the method, apparatus, and non-transitory computer-readable medium described herein, the multi-port downlink broadcast signal communications may be enabled in accordance with the paging type.

In some examples of the method, apparatus, and non-transitory computer-readable medium described herein, multi-rank uplink communications may be enabled during a RA procedure in accordance with enablement of the multi-port downlink broadcast signal communications and based on the second downlink broadcast signal including a downlink reference signal.

In some examples of the method, apparatus, and non-transitory computer-readable medium described herein, the first paging message may be associated with one or more first symbols in a downlink control channel and one or more second symbols in a downlink shared channel.

In some examples of the method, apparatus, and non-transitory computer-readable medium described herein, the first paging message may be output via the one or more first symbols in the downlink control channel.

In some examples of the method, apparatus, and non-transitory computer-readable medium described herein, the second downlink broadcast signal includes a downlink reference signal output via the one or more second symbols in the downlink shared channel.

In some examples of the method, apparatus, and non-transitory computer-readable medium described herein, the first paging message includes a first portion of a paging data message.

In some examples of the method, apparatus, and non-transitory computer-readable medium described herein, the second downlink broadcast signal includes a second paging message that further includes a second portion of the paging data message.

In some examples of the method, apparatus, and non-transitory computer-readable medium described herein, the first downlink broadcast signal includes a first SIB message.

In some examples of the method, apparatus, and non-transitory computer-readable medium described herein, the second downlink broadcast signal includes a second SIB message or a downlink reference signal.

In some examples of the method, apparatus, and non-transitory computer-readable medium described herein, participating in communication of the one or more signals that enable the multi-port downlink broadcast signal communications may include operations, features, means, or instructions for outputting configuration information that indicates on-demand SIB messages may be associated with multi-port communications and indicates periodic SIB messages may be associated with single-port communications.

In some examples of the method, apparatus, and non-transitory computer-readable medium described herein, the first SIB message may be a first on-demand SIB message.

In some examples of the method, apparatus, and non-transitory computer-readable medium described herein, the first downlink broadcast signal and the second downlink broadcast signal may be received via different ports in accordance with the first on-demand SIB message.

In some examples of the method, apparatus, and non-transitory computer-readable medium described herein, participating in communication of the one or more signals that enable the multi-port downlink broadcast signal communications may include operations, features, means, or instructions for outputting a control message that schedules the first SIB message, where the control message indicates a SIB transmission type of the first SIB message.

In some examples of the method, apparatus, and non-transitory computer-readable medium described herein, the SIB transmission type may be indicative of multi-port communications.

In some examples of the method, apparatus, and non-transitory computer-readable medium described herein, the multi-port downlink broadcast signal communications may be enabled in accordance with the SIB transmission type.

In some examples of the method, apparatus, and non-transitory computer-readable medium described herein, participating in communication of the one or more signals that enable the multi-port downlink broadcast signal communications may include operations, features, means, or instructions for obtaining a request message indicative of a SIB transmission type for the first SIB message.

In some examples of the method, apparatus, and non-transitory computer-readable medium described herein, the requested SIB transmission type may be indicative of multi-port communications.

In some examples of the method, apparatus, and non-transitory computer-readable medium described herein, the multi-port downlink broadcast signal communications may be enabled in accordance with the requested SIB transmission type.

In some examples of the method, apparatus, and non-transitory computer-readable medium described herein, the request message includes an uplink WUS.

In some examples of the method, apparatus, and non-transitory computer-readable medium described herein, the first SIB message includes control information and the second downlink broadcast signal includes a second SIB message that further includes data associated with the first SIB message.

In some examples of the method, apparatus, and non-transitory computer-readable medium described herein, the first downlink broadcast signal includes a downlink message of a RA procedure.

In some examples of the method, apparatus, and non-transitory computer-readable medium described herein, the second downlink broadcast signal includes a downlink reference signal or a downlink data message associated with the downlink message of the RA procedure.

In some examples of the method, apparatus, and non-transitory computer-readable medium described herein, participating in communication of the one or more signals that enable the multi-port downlink broadcast signal communications may include operations, features, means, or instructions for obtaining a first uplink message of the RA procedure via a first set of resources.

In some examples of the method, apparatus, and non-transitory computer-readable medium described herein, the first set of resources corresponds to a first type of RA procedure from a set of multiple types of RA procedures.

In some examples of the method, apparatus, and non-transitory computer-readable medium described herein, the first type of RA procedure enables multi-port communications.

In some examples of the method, apparatus, and non-transitory computer-readable medium described herein, the multi-port downlink broadcast signal communications may be enabled in accordance with the first type of RA procedure.

In some examples of the method, apparatus, and non-transitory computer-readable medium described herein, participating in communication of the one or more signals that enable the multi-port downlink broadcast signal communications may include operations, features, means, or instructions for outputting a control message associated with the first downlink message of the RA procedure, where the control message indicates a transmission type of the first downlink message of the RA procedure.

In some examples of the method, apparatus, and non-transitory computer-readable medium described herein, the transmission type may be indicative of multi-port communications.

In some examples of the method, apparatus, and non-transitory computer-readable medium described herein, the multi-port downlink broadcast signal communications may be enabled in accordance with the transmission type.

In some examples of the method, apparatus, and non-transitory computer-readable medium described herein, the downlink message includes a first downlink message of the RA procedure and the method, apparatuses, and non-transitory computer-readable medium may include further operations, features, means, or instructions for obtaining, via a second uplink message of the RA procedure, a report indicative of a rank indicator, a PMI, or both, in response to enablement of the multi-port downlink broadcast signal communications.

In some examples of the method, apparatus, and non-transitory computer-readable medium described herein, the downlink message includes a second downlink message of the RA procedure and the method, apparatuses, and non-transitory computer-readable medium may include further operations, features, means, or instructions for obtain, via a feedback message in response to the second downlink message of the RA procedure or via another uplink message, a report indicative of a rank indicator, a PMI, or both, in response to enablement of the multi-port downlink broadcast signal communications.

In some examples of the method, apparatus, and non-transitory computer-readable medium described herein, the first downlink broadcast signal includes a DMRS and the second downlink broadcast signal includes another downlink reference signal.

In some examples of the method, apparatus, and non-transitory computer-readable medium described herein, the DMRS and the downlink reference signal may be outputted via a same set of resources in a time domain or a same set of resources in a frequency domain.

In some examples of the method, apparatus, and non-transitory computer-readable medium described herein, the DMRS may be associated with a first power offset relative to an SSB.

In some examples of the method, apparatus, and non-transitory computer-readable medium described herein, the downlink reference signal may be associated with a second power offset relative to the SSB, the second power offset different from the first power offset.

In some examples, the apparatus may further include one or more antennas configured to output the first downlink broadcast signal and the second downlink broadcast signal.

### BRIEF DESCRIPTION OF THE DRAWINGS

FIG. 1 shows an example of a wireless communication system.

FIG. 2 shows an example of a signaling diagram supports multi-port communications for downlink broadcast signaling.

FIGS. 3A and 3B show examples of signaling diagrams that supports multi-port communications for downlink broadcast signaling.

FIGS. 4A and 4B show examples of signaling diagrams that supports multi-port communications for downlink broadcast signaling.

FIGS. 5A and 5B show examples of signaling diagrams that supports multi-port communications for downlink broadcast signaling.

FIGS. 6A and 6B shows examples of resource configurations that supports multi-port communications for downlink broadcast signaling.

FIG. 7 shows an example of a process flow that supports multi-port communications for downlink broadcast signaling.

FIG. 8 shows a block diagram of a processing system that supports multi-port communications for downlink broadcast signaling.

FIG. 9 shows a diagram of a system including a device that supports multi-port communications for downlink broadcast signaling.

FIG. 10 shows a block diagram of a processing system that supports multi-port communications for downlink broadcast signaling.

FIG. 11 shows a diagram of a system including a device that supports multi-port communications for downlink broadcast signaling.

FIGS. 12 and 13 show flowcharts illustrating methods that support multi-port communications for downlink broadcast signaling.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems may support random access channel (RACH) procedures, which may simply be referred to as RA procedures, to establish a connection between a user equipment (UE) and a network entity. In such cases, during a RA procedure, a UE may generate (e.g., measure, collect, acquire) channel state information (CSI) for use by the UE, the network entity, or both, (e.g., for channel sounding, to enable high data rates). To generate the CSI, the UE may measure one or more reference signals. However, resources available for reception of the one or more reference signals during the RA procedure may be limited (e.g., as compared to resources available prior to or after connection establishment) due to connection establishment signaling being allocated resources with a higher priority that the one or more reference signals, and the limited resources may limit an ability of the UE to generate the CSI. In other words, completion of connection establishment between the UE and the network entity (e.g., completion of the RA procedure) may be at least partially based on an ability of the UE to generate CSI (e.g., a speed at which the UE can generate CSI, a length of a duration over which the UE generates CSI). Thus, because connection establishment signaling may be of a higher priority than one or more reference signals to be used for generation of CSI, resources available for communications during connection establishment may be allocated for the connection establishment signaling rather than for the one or more reference signals, which may delay the ability of the UE to generate CSI, thus delaying connection establishment until the UE completes generation of the CSI (e.g., latency of connection establishment increases).

Aspects of the subject matter described in this disclosure relate to multi-port (e.g., two port) communications for downlink broadcast signaling (e.g., downlink broadcast signaling received prior to radio resource control (RRC) configuration of the UE) to enable a higher data rate (e.g., as compared to single-port communications for downlink broadcast signaling) and reduced latency for connection establishment. For example, a UE may have multiple antenna elements (e.g., physical components). Additionally, the UE may have one or more ports (e.g., logical components), where a port is a logical signal path that may map to one or more antenna elements.

In some cases, the UE may communicate via multiple ports (e.g., multi-port communications). For example, a first subset of antenna elements, from the multiple antenna elements, may map to a first port (e.g., a first logical signal path) and a second subset of antenna elements, from the multiple antenna elements, may map to a second port (e.g., a second logical signal path), where the first subset is different from the second subset. In other words, the first port may define the first logical signal path via the first subset of antenna elements and the second port may define the second logical signal path via the second subset of antenna elements. In another example, the first subset of antenna elements may map to both the first port and the second port. However, the first port may be different from the second port based on a method in which the first subset of antenna elements is mapped to each port. For example, the first port may use a first amplitude, a first phase, or both, on each antenna element in the first subset of antenna elements and the second port may use a second amplitude, a second phase, or both, on each antenna element in the first subset of antenna elements, where the first amplitude is different than the second amplitude, the first phase is different from the second phase, or both. Thus, for multi-port communications, the UE may receive a first signal via the first port and may receive a second signal via the second port. In some cases, the first signal and the second signal may be different signals (e.g., multi-port transmission with multi-rank). In some other cases, the first signal and the second signal may be the same signal (e.g., a multi-port transmission with a rank 1). In yet some other cases, the first signal and the second signal may be the same set of signals going through different precoding (e.g., a precoded multi-port transmission with a rank greater than 1).

In some cases, the multiple antenna elements of the UE may be grouped into one or more antenna arrays. Thus, in some cases, one or more antenna elements mapped to a port may be from one antenna array, or may be from more than one antenna array. Similarly, multiple ports may be associated with a same set of one or more antenna arrays or a different set of one or more antenna arrays. A first set of ports, which may be referred to as receive (Rx) ports, may be used to receive signals from a network entity and a second set of ports, which may be referred to a transmit (Tx) ports, may be used to transmit signals to the network entity. By communicating via multiple ports (e.g., by performing multi-port communications), the UE may have the capability to achieve higher throughput (e.g., higher data rates) due to a capability of the UE to communicate multiple data streams at a same time (e.g., simultaneously, via a same set of resources in a time domain).

Accordingly, the UE may support multi-port downlink broadcast signal communications prior to RRC configuration of the UE to enable communication of downlink broadcast signals, such as one or more paging messages, one or more system information block (SIB) messages, one or more downlink messages, one or more reference signals, or any combination thereof, via multiple ports. In other words, when multi-port downlink broadcast signal communications are enabled, rather the receiving one downlink broadcast signal via one Rx port of the UE (e.g., from the set of Rx ports), the UE may receive multiple downlink broadcast signals via multiple (e.g., two) Rx ports of the UE (e.g., from the set of Rx ports).

According to one or more aspects of the present disclosure, the UE (e.g., and the network entity) may enable the multi-port downlink broadcast signal communications for downlink paging messages, which may be referred to herein as multi-port downlink paging. For example, the multiple downlink broadcast signals may include a paging message (e.g., paging physical downlink shared channel (PDSCH)) and a reference signal. The UE may receive the paging message via a first Rx port (e.g., from the set of Rx ports) and may receive the reference signal via a second Rx port (e.g., from the set of Rx ports). In another example, the multiple downlink broadcast signals may include a first portion of a paging message (e.g., a first portion of a paging PDSCH) and a second portion of the paging message (e.g., a second portion of the paging PDSCH). The UE may receive the first portion of the paging message via the first Rx port and may receive the second portion of the paging message via the second Rx port.

The UE may enable the multi-port downlink paging based on the UE receiving (e.g., communicating, participating in communication of) one or more signals that explicitly or implicitly enable the multi-port downlink paging. For example, the UE my receive a control message configuring a paging occasion (PO) for multi-port downlink paging, may receive a paging DCI indicating that a corresponding paging PDSCH is a multi-port downlink paging message, may receive a paging early indication (PEI) indicating that an upcoming paging message is a multi-port downlink paging message, or any combination thereof.

Additionally, or alternatively, the UE (e.g., and the network entity) may enable the multi-port downlink broadcast signal communications for downlink system information block (SIB) messages, which may be referred to herein as multi-port SIB communications. For example, the multiple downlink broadcast signals may include a SIB message and a reference signal. The UE may receive the SIB message via the first Rx port and may receive the reference signal via the second Rx port. In another example, the multiple downlink broadcast signals may include a first portion of a SIB message (e.g., a first portion of a SIB PDSCH) and a second portion of the SIB message (e.g., a second portion of the SIB PDSCH). The UE may receive the first portion of the SIB message via the first Rx port and may receive the second portion of the SIB message via the second Rx port.

The UE may enable the multi-port SIB communications based on the UE communicating (e.g., transmitting, receiving, participating in communication of) one or more signals that explicitly or implicitly enable the multi-port SIB communications. For example, the UE my receive a control message configuring on-demand SIB messages as multi-port SIB communications (e.g., while other SIB messages may be configured as single-port SIB communications), may receive another control message that schedules a SIB message, where the second control message indicates the SIB message is a multi-port SIB communication, or both. Additionally, or alternatively, the UE may transmit an uplink wake-up signal (WUS) requesting that a SIB message be a multi-port SIB communication.

Additionally, or alternatively, the UE (e.g., and the network entity) may enable the multi-port downlink broadcast signal communications for downlink messages of a RA procedure (e.g., RACH procedure), which may be referred to herein as multi-port downlink RA communications. For example, the multiple downlink broadcast signals may include a downlink message of the RA procedure (e.g., msg2, msgB, msg4) and a reference signal. The UE may receive the downlink message of the RA procedure via the first Rx port and may receive the reference signal via the second Rx port. In another example, the multiple downlink broadcast signals may include a first portion of a downlink message of the RA procedure (e.g., a first portion of a msg2 PDSCH, a msgB PDSCH, or a msg4 PDSCH) and a second portion of the downlink message of the RA procedure (e.g., a second portion of the msg2 PDSCH, the msgB PDSCH, or the msg4 PDSCH). The UE may receive the first portion of the downlink message via the first Rx port and may receive the second portion of the downlink message via the second Rx port.

The UE may enable the multi-port downlink RA communications based on the UE receiving one or more signals that explicitly or implicitly enable the multi-port downlink RA communications. For example, the UE my receive a control message configuring a first type of RA procedure (e.g., group B RACH) for multi-port downlink RA communications, may receive a control message associated with the downlink message of the RA procedure (e.g., msg2 DCI) that indicates the downlink message of the RA procedure is part of a multi-port downlink RA communication, or both. In some cases, multi-port downlink RA communications being enabled during an RA procedure may further enable multi-rank uplink transmissions during the RA procedure. A multi-rank uplink transmission may be a transmission of uplink data, by the UE, via multiple data streams over same frequency and time resources, where a value of the rank corresponds to a quantity of the multiple data streams and where each data stream is transmitted via a corresponding antenna. For example, a rank of two corresponds two data streams transmitted via two antennas.

Particular aspects of the subject matter described in this disclosure demonstrate improvements in connection establishment latency. In some examples, by enabling multi-port downlink broadcast signal communications (e.g., by supporting communication of broadcast signals via multiple ports), the described techniques may enable the UE to increase a data rate of communication (e.g., as compared to single-port communications). Additionally, or alternatively, by enabling multi-port downlink broadcast signal communications in which one of the multi-port downlink broadcast signals includes a reference signal, the described techniques may enable the UE to collect CSI based on the reference signal prior to RRC configuration of the UE (e.g., when resources available for CSI collection may be limited), thus decreasing latency of connection establishment. Additionally, or alternatively, by enabling multi-port downlink broadcast signal communications, the described techniques may enable the UE to sound multiple Rx ports (e.g., evaluate a performance of each Rx port of the multiple Rx ports), such that the UE may select an Rx port of the multiple ports with a best performance (e.g., out of the multiple Rx ports).

In particular, by enabling multi-port downlink paging, the described techniques may enable the UE to perform channel sounding (e.g., to measure and characterize a channel) via the multiple ports (e.g., the first Rx port and the second Rx port), which may enable the UE, the network entity, or both, to adapt one or more subsequent communications in accordance with more channel information than achieved by channel sounding via a single port. Additionally, or alternatively, by enabling multi-port SIB communications, and more specifically by enabling a UE to request single-port or multi-port SIB communications, the described techniques may enable UEs (e.g., as defined herein) to request multi-port SIB communications when a reference signal receive power (RSRP) of the UE exceeds a threshold (e.g., the UE is a high geometry UE, as defined herein), thus enabling the UE to achieve a higher data rate, a higher rank, or both. Additionally, or alternatively, by enabling multi-port downlink RA communications, the described techniques may enable the UE to collect and report CSI while performing an RA procedure, thus enabling configuration of the UE (e.g., RRC configuration) to be based on the reported CSI.

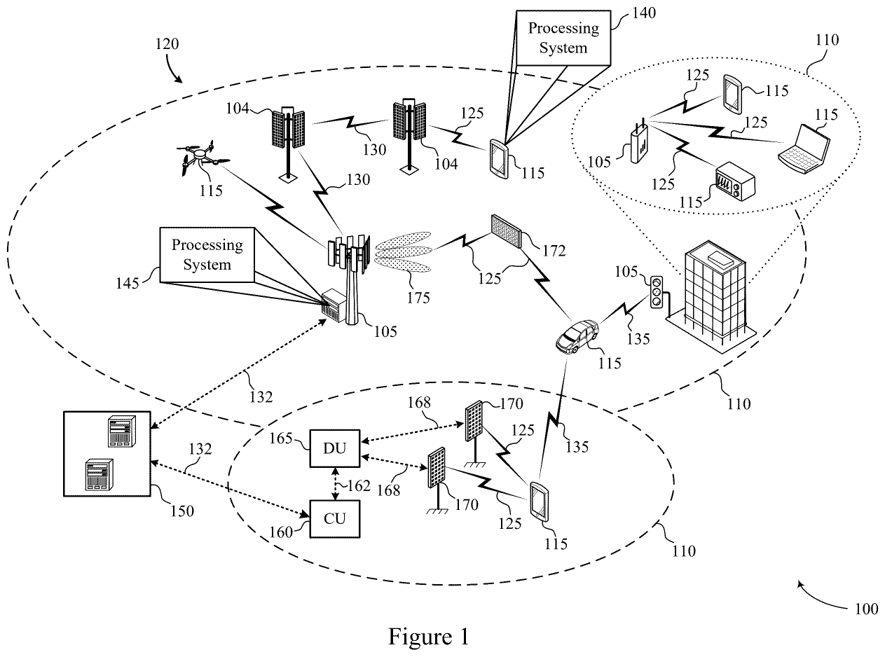

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The electromagnetic spectrum is often subdivided, based on frequency/wavelength, into various classes, bands, channels, etc. In 5G NR two initial operating bands have been identified as frequency range designations FR1 (410 MHz 7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz 71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Some wireless communications systems, such as the wireless communications system 100, may support single port transmissions (e.g., signals) for broadcast channels (e.g., signals). For example, a network entity 105 may transmit a single-port synchronization signal block (SSB), a single-port physical broadcast channel (PBCH), a single-port physical downlink control channel (PDCCH), a single-port physical downlink shared channel (PDSCH), or any combination thereof, for a broadcast channel (e.g., remaining minimum system information (RMSI), system information block (SIB), paging, etc.).

Additionally, or alternatively, the wireless communications system 100, may support multi-port synchronization signal block (SSB) communications (e.g., two-port SSB). For example, a network entity 105 may transmit, via a first port, an SSB (e.g., including a primary synchronization signal (PSS), a secondary synchronization signal (SSS), and a physical broadcast channel (PBCH)) and, via a second port, another reference signal. In such cases, a UE 115 may use both of the SSB transmitted via the first port and the other reference signal transmitted via the second port for SSB selection. The multi-port signal (e.g., SSB and other reference signal) may enable the UE to evaluate a channel corresponding to the SSB in accordance with both rank and signal strength (e.g., rather than just signal strength). For example, the UE 115 may select an SSB with a lower signal strength but with a higher rank (e.g., and a higher capacity).

Devices of the wireless communication system 100 may be configured to support one or more aspects of the described techniques for multi-port communications for downlink broadcast signaling. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support multi-port downlink broadcast signal communications, which may enable the UE to increase a data rate of communication (e.g., as compared to single-port communications), may enable the UE to collect CSI based on the reference signal prior to RRC configuration of the UE (e.g., when resources available for CSI collection may be limited), thus decreasing latency of connection establishment, and may enable the UE to sound multiple Rx ports (e.g., evaluate a performance of each Rx port of the multiple Rx ports), such that the UE may select an Rx port of the multiple ports with a best performance (e.g., out of the multiple Rx ports).

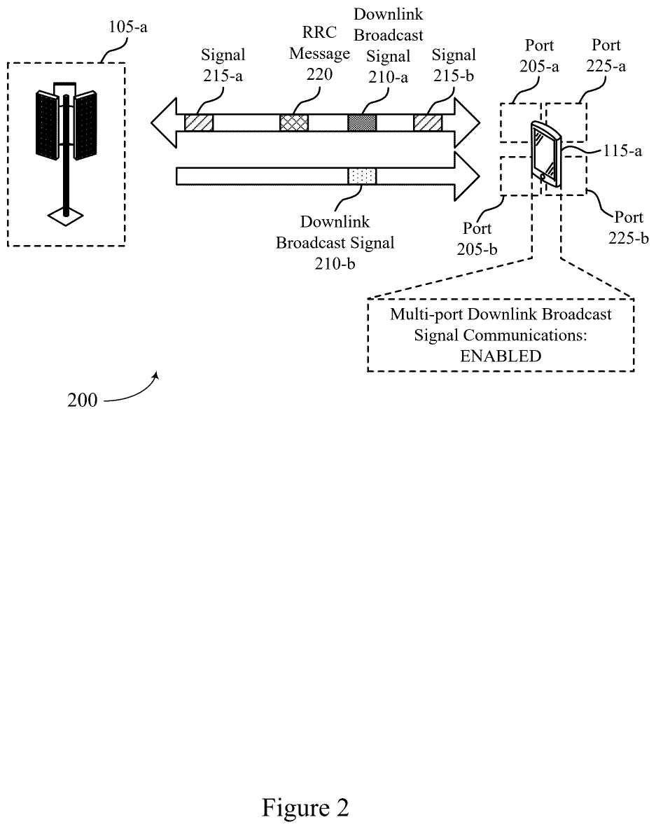

FIG. 2 shows an example of a signaling diagram 200 that supports multi-port communications for downlink broadcast signaling. The signaling diagram 200 may implement or be implemented by aspects of the wireless communication system 100. For example, the signaling diagram 200 may include one or more UEs 115 (e.g., a UE 115-a), one or more network entities 105 (e.g., a network entity 105-a), or both, which may be examples of the corresponding devices described herein, including with reference to FIG. 1.

Some wireless communications systems may support RA procedures to establish a connection between a UE 115, such as the UE 115-a, and a network entity 105, such as the network entity 105-a. In such cases, during a RA procedure, the UE 115-a may generate (e.g., measure, collect, acquire) CSI for use by the UE 115-a, the network entity 105-a, or both, (e.g., for channel sounding, to enable high data rates, to reduce overall latency). To generate the CSI, the UE 115-a may measure one or more reference signals. However, resources available for reception of the one or more reference signals during the RA procedure may be limited (e.g., as compared to resources available prior to or after connection establishment) due to connection establishment signaling being allocated resources with a higher priority that the one or more reference signals, and the limited resources may limit an ability of the UE 115-a to generate the CSI. In other words, completion of connection establishment between the UE 115-a and the network entity 105-a (e.g., completion of the RA procedure) may be at least partially based on an ability of the UE 115-a to generate CSI (e.g., a speed at which the UE 115-a generates the CSI, a length of a duration over which the UE 115-a completes generation of the CSI). Thus, because connection establishment signaling may be of a higher priority than one or more reference signals to be used for generation of CSI, resources available for communications during connection establishment may be allocated for the connection establishment signaling rather than for the one or more reference signals, which may delay the ability of the UE 115 to generate CSI, thus delaying connection establishment until the UE 115 completes generation of the CSI (e.g., latency of connection establishment increases).

Accordingly, techniques described herein may support multi-port (e.g., two port) communications for downlink broadcast signaling (e.g., prior to RRC configuration of the UE 115-a) to enable a higher data rate (e.g., as compared to single-port communications for downlink broadcast signaling) and reduced latency for connection establishment. For example, the UE 115-a may have multiple antenna ports (e.g., logical antenna ports, physical antenna ports, or both) used for transmitting and receiving signals, where a first set of ports, which may be referred to as Rx ports, may be used to receive signals from the network entity 105-a, and a second set of ports, which may be referred to a Tx ports, may be used to transmit signals to the network entity 105-a. By communicating via multiple ports (e.g., by performing multi-port communications), the UE 115-a may be capable of achieving higher throughput (e.g., higher data rates) due to a capability of the UE 115-a to communicate multiple data streams at a same time.

Accordingly, the UE 115-a may support multi-port downlink broadcast signal communications (e.g., prior to RRC configuration of the UE 115-a via an RRC message 220) to enable communication of downlink broadcast signals 210 at a higher data rate (e.g., as compared to single-port downlink broadcast signal communications), thus reducing latency of connection establishment. For example, the UE 115-a may have multiple Rx ports 205, which may simply be referred to as ports 205, including a port 205-a and a port 205-b, and multiple Tx ports, which may simply be referred to as ports 225, including a port 225-a and a port 225-b. The ports 205 may be grouped into one or more groups. For example, the ports 205 may be part of a single group, or the ports 205 may be part of multiple groups. In some cases, each group (e.g., the single group, or each group of the multiple groups) may correspond to an antenna array of the UE 115-a, where each antenna array includes one or more ports 205. For example, the port 205-a may be part of a first antenna array (e.g., a first group) and the port 205-b may be part of a second antenna array (e.g., a second group). Alternatively, the port 205-a and the port 205-b may be part of a same antenna array (e.g., a same group).

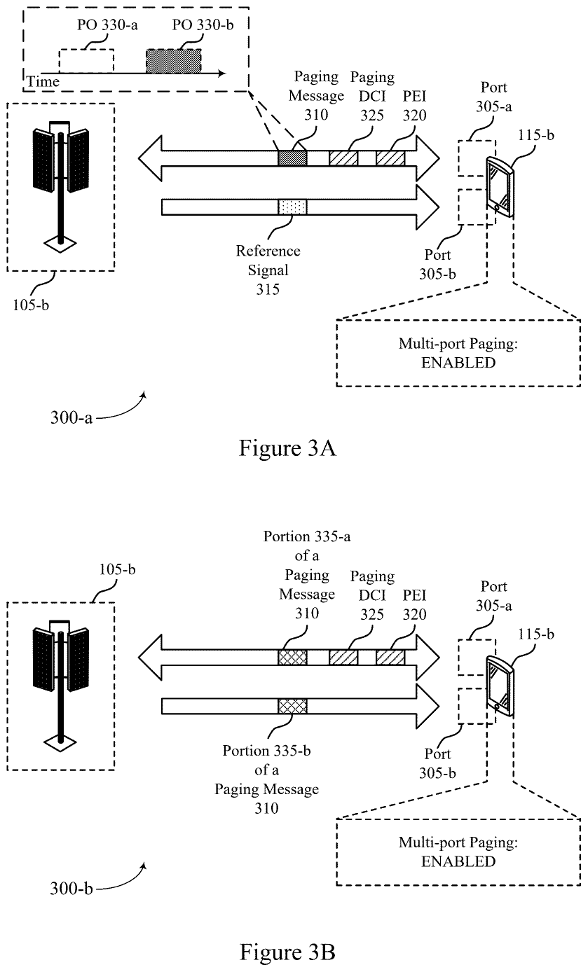

In some cases, the UE 115-a may communicate (e.g., participate in communication of, transmit, receive) one or more signals 215 that explicitly or implicitly enable the multi-port downlink broadcast signal communications, as described further with reference to FIG. 3A through FIG. 5B. For example, the UE 115-a may transmit a signal 215-a that enables the multi-port downlink broadcast signal communications, may receive a signal 215-b that enables the multi-port downlink broadcast signal communications, or both. In some cases, the one or more signals 215 may explicitly enable the multi-port downlink broadcast signal communications by including an indicator that the multi-port downlink broadcast signal communications. The indicator may be a configuration for multi-port downlink broadcast signal communications, a type of downlink broadcast signal communications indicating multi-port, or the like thereof. Conversely, the one or more signals 215 may implicitly enable the multi-port downlink broadcast signal communications based on one or more characteristics of the one or more signals 215 being associated with multi-port downlink broadcast signal communications (e.g., when the one or more signals 215 do not include the indicator). For example, a first format of the one or more signals 215 may correspond to multi-port downlink broadcast signal communications and a second format of the one or more signals 215 may correspond to single-port downlink broadcast signal communications. In another example, one or more first resources used to communicate the one or more signals 215 may correspond to multi-port downlink broadcast signal communications and one or more second resources used to communicate the one or more signals 215 may correspond to single-port downlink broadcast signal communications. In another example, a first type of information indicated via the one or more signals 215 may correspond to multi-port downlink broadcast signal communications and a second type of information indicated via the one or more signals 215 may correspond to single-port downlink broadcast signal communications.

Thus, when multi-port downlink broadcast signal communications are enabled, the UE 115-a may receive a downlink broadcast signal 210-a via the port 205-a and may receive a downlink broadcast signal 210-b via the port 205-b, where the port 205-a is different from the port 205-b. In such cases, the UE 115-a may receive the downlink broadcast signal 210-a via the port 205-a and the downlink broadcast signal 210-b via the port 205-b prior to reception of the RRC message 220 (e.g., RRCConfiguration message) that indicates a configuration of the UE 115-a. In other words, the UE 115-a may receive the downlink broadcast signal 210-a via the port 205-a and the downlink broadcast signal 210-b via the port 205-b prior to completion of a connection establishment procedure.

Though described in the context of two ports 205, this is not to be regarded as a limitation of the present disclosure. In this regard, any quantity of ports 205 may be considered with regards to the techniques described herein.

FIGS. 3A and 3B show examples of signaling diagrams 300 (e.g., a signaling diagram 300-a and a signaling diagram 300-b) that supports multi-port communications for downlink broadcast signaling. The signaling diagrams 300 may implement or be implemented by aspects of the wireless communication system 100, the signaling diagram 200, or both. For example, the signaling diagrams 300 may include one or more UEs 115 (e.g., a UE 115-b), one or more network entities 105 (e.g., a network entity 105-b), or both, which may be examples of the corresponding devices described herein, including with reference to FIG. 1.

In some cases, the multi-port downlink broadcast signal communications, as described with reference to FIG. 2, may be multi-port downlink paging, such that, in some cases, the downlink broadcast signal 210-a is a paging message 310 and the downlink broadcast signal 210-b is a reference signal 315 (e.g., one or more reference signals 315), as described with reference to the signaling diagram 300-a, or, in some other cases, the downlink broadcast signal 210-a is a portion 335-a of a paging message 310 and the downlink broadcast signal 210-b is a portion 335-b of the paging message 310, as described with reference to the signaling diagram 300-b.

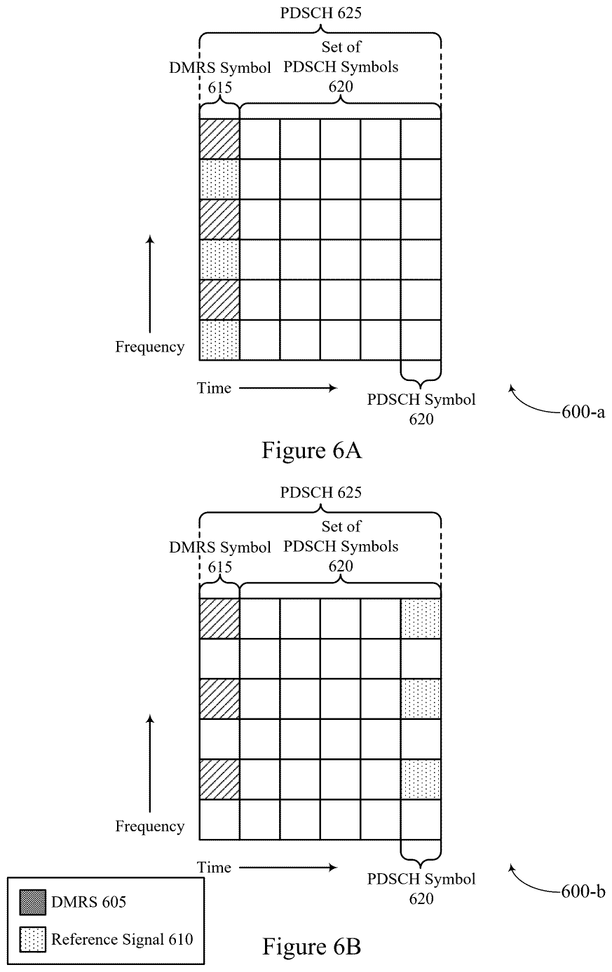

For example, in some cases, as depicted in the signaling diagram 300-a (e.g., when paging includes one or more multi-port reference signals 315), the UE 115-a may receive a paging message 310 with a multi-port reference signal 315. That is, the UE 115-b may receive (e.g., and the network entity 105-a may transmit) the paging message 310 via a port 305-a and may receive the reference signal 315 via a port 305-b, different from the port 305-a, such that the UE 115-a may perform channel sounding via multiple ports 305 (e.g., via the port 305-a and the port 305-b). In some examples, as described with reference to a resource configuration 600-a depicted in FIG. 6A, the paging message 310 (e.g., paging PDSCH) may include one or more DMRS symbols and one or more PDSCH symbols (e.g., paging PDSCH symbols), where the network entity 105-b may transmit the reference signal 315 via a DMRS symbol that also includes one or more DMRS (e.g., the reference signal 315 may be transmitted by the network entity 105-b using another DMRS port in the paging message 310). In some other examples, the network entity 105-b may transmit the reference signal 315 via a PDSCH symbol (e.g., of the one or more paging PDSCH symbols) different from the one or more DMRS symbols (e.g., similar to CSI-RS) with a lower density compared to DMRS).

In some other cases, as depicted in the signaling diagram 300-b, the UE 115-b may receive different portions 335 of a paging message 310 (e.g., paging PDSCH) via multiple ports 305. For example, the UE 115-b may receive (e.g., and the network entity 105-b may transmit) a portion 335-a of the paging message 310 (e.g., a first portion of the paging message 310) via the port 305-a and may receive a portion 335-b of the paging message 310 (e.g., a second portion of the paging message 310) via the port 305-b, different from the port 305-a. In such cases, the portion 335-a of the paging message 310 may include a first portion of data (e.g., a first portion of a paging PDSCH, one or more first DMRSs) and the portion 335-b of the paging message 310 may include a second portion of data (e.g., a second portion of the paging PDSCH, one or more second DMRSs). In some cases, one of the ports 305 used to receive a portion 335 of the paging message 310 may be a same port 305 used to receive a paging DCI 325. For example, as depicted in FIG. 3B, the UE 115-b may receive a paging DCI 325 via the port 305-a, where the paging DCI 325 schedules the paging message 310. Thus, the UE 115-b may receive the portion 335-a of the paging message 310 via the port 305-a (e.g., the same port 305 used to receive the paging DCI 325) and may receive the portion 335-b of the paging message 310 via the port 305-b. In some cases, each portion 335 may include one or more DMRS, as described with reference to FIGS. 6A and 6B. The UE 115-b may also use multi-port DMRS to perform channel sounding of a multiple input multiple output (MIMO) channel. Additionally, or alternatively, multi-port downlink paging may be enabled for outdoor Fixed Wireless Access (FWA) devices.

In some cases, not all paging messages 310 may be communicated via multiple ports 305 (e.g., not all paging messages 310 may support multi-port paging). For example, the network entity may configure different paging occasions (POs) 330 with different types of paging, such as single-port paging and multi-port paging. For example, a PO 330-a may be used for single-port paging and a PO 330-b may be used for multi-port paging. The different types of paging (e.g., different paging types) may include one or more of single-port paging, a first type of multi-port paging (e.g., multi-port reference signal 315 with single-port paging PDSCH), as described with reference to FIG. 3A, a second type of multi-port paging (e.g., single-port reference signal 315 with multi-port paging PDSCH), as described with reference to FIG. 3B, and a third type of multi-port paging (e.g., multi-port reference signal 315 with multi-port paging PDSCH), which may be a combination of the first type and the second type.

In some examples, a paging type (e.g., single-port or multi-port) for each PO 330 may be based on an identifier associated with the UE 115-b, the network entity 105-b may configure the paging type for each PO 330 when the UE 115-b transitions from a connected state to an idle or inactive state, or both. Additionally, or alternatively, the UE 115-b may receive a paging DCI 325 that indicates a paging type of a corresponding paging message 310. For example, the paging DCI 325 may indicate whether the corresponding paging message 310 (e.g., paging PDSCH) is a single-port communication, a multi-port reference signal communication (e.g., as depicted in the signaling diagram 300-a), or a multi-port paging PDSCH communication (e.g., as depicted in the signaling diagram 300-b). Additionally, or alternatively, the UE 115-b may receive a paging PEI 320 indicating a paging type of a corresponding paging message.

In some cases, the network entity 105-b may indicate correspondence between each PO 330 and each RACH occasion (RO) (e.g., preamble). For example, for RA with a corresponding RO, the UE 115-b may transmit an indication of a rank indicator (RI), an indication of a precoding matrix indicator (PMI), or both, via a msg3 physical uplink control channel (PUSCH) or a msgA PUSCH. Additionally, or alternatively, the UE 115-b may enable multi-rank (e.g., multi-layer) uplink transmissions in the RA (e.g., msg1 PUSCH, msg3 PUSCH, msgA PUSCH) based on reception of a multi-port reference signal 315.

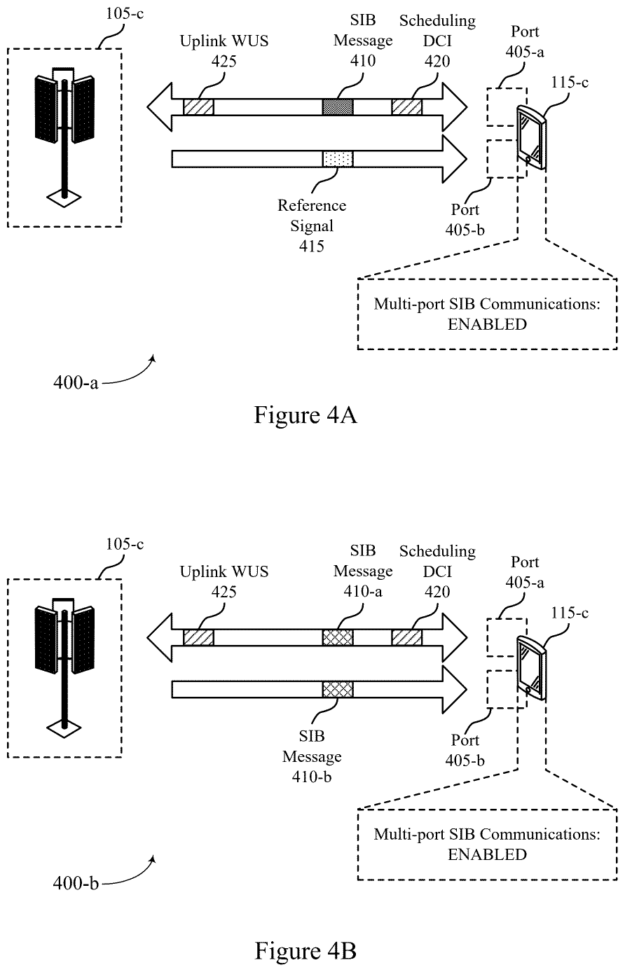

FIGS. 4A and 4B show examples of signaling diagrams 400 (e.g., a signaling diagram 400-a and a signaling diagram 400-b) that supports multi-port communications for downlink broadcast signaling. The signaling diagrams 400 may implement or be implemented by aspects of the wireless communication system 100, the signaling diagrams 200, the signaling diagrams 300, or any combination thereof. For example, the signaling diagrams 400 may include one or more UEs 115 (e.g., a UE 115-c), one or more network entities 105 (e.g., a network entity 105-c), or both, which may be examples of the corresponding devices described herein, including with reference to FIG. 1.

In some cases, the multi-port downlink broadcast signal communications, as described with reference to FIG. 2, may be multi-port SIB communications, such that, in some cases, the downlink broadcast signal 210-a is a SIB message 410 and the downlink broadcast signal 210-b is a reference signal 415 (e.g., one or more reference signals 415), as described with reference to the signaling diagram 400-a, or, in some other cases, the downlink broadcast signal 210-a is a SIB message 410-a and the downlink broadcast signal 210-b is a SIB message 410-b, as described with reference to the signaling diagram 400-b.

For example, in some cases, as depicted in the signaling diagram 400-a, the UE 115-c may receive the SIB message 410 with a multi-port reference signal 415. That is, the UE 115-a may receive the SIB message 410 via a port 405-a and may receive the reference signal 415 via the port 405-b, different from the port 405-a. In some other cases, as depicted in the signaling diagram 400-a, the UE 115-c may receive a SIB message 410 (e.g., SIB PDSCH) via multiple ports 405 (e.g., multi-port SIB PDSCH). That is, the UE 115-a may receive the SIB message 410-a (e.g., a first portion of the SIB message 410, a first portion of a SIB PDSCH) via the port 405-a and may receive the SIB message 410-b (e.g., a second portion of the SIB message 410, a second portion of a SIB PDSCH) via the port 405-b, different from the port 405-a. In such cases, the UE 115-a may transmit an indication of an RI (e.g., rank feedback), an indication of a PMI (e.g., PMI feedback), or both, via a msg3 PUSCH or a msgA PUSCH. In some cases, the UE 115-a may enable reception of the SIB message 410 via the multiple ports 405 (e.g., multi-port SIB PDSCH) for dedicated deployments with outdoor FWA devices, while the UE 115-a may enable reception of the SIB message 410 and the reference signal 415 via the multiple ports 405 (e.g., multi-port reference signal 415) for mixed deployments for multiple UEs 115.

In some cases, the network entity 105-c may enable multi-port SIB communications for on-demand SIB messages 410 and may not enable (e.g., disable) multi-port SIB communications for other SIB messages 410 (e.g., periodic SIB messages 410, regular SIB messages 410 may be single-port). Additionally, or alternatively, the network entity 105-c may transmit a scheduling DCI 420 (e.g., scheduling a SIB message 410) indicating a SIB transmission type (e.g., multi-port or single-port) of a corresponding SIB message 410.

Additionally, or alternatively, for on-demand SIB messages 410, the UE 115-c may request for the on-demand SIB message 410 to be single-port or multi-port, which may enable high geometry UEs 115 to achieve higher data rates with higher ranks. In some cases, the network entity 105-c may configure different uplink wake-up signal (WUS) sequences to request a single-port SIB message 410 or a multi-port SIB message 410. For example, the UE 115-c may transmit an uplink WUS 425 indicative of a first sequence to request a single-port SIB message 410 and may transmit an uplink WUS 425 indicative of a second sequence to request a multi-port SIB message 410. Alternatively, the network entity 105-c may configure different uplink WUS transmission occasions to request a single-port SIB message 410 or a multi-port SIB message 410. For example, the UE 115-c may transmit an uplink WUS 425 indicative via a first transmission occasion to request a single-port SIB message 410 and may transmit an uplink WUS 425 via second transmission occasion to request a multi-port SIB message 410.

As described herein, a high geometry UE 115 may be a UE 115 associated with an RSRP greater than or equal to a threshold RSRP (e.g., configured by the network entity 105-c), a signal to noise ratio (SNR) greater than or equal to a threshold SNR (e.g., configured by the network entity 105-c), a signal to interference and noise (SINR) greater than or equal to a threshold SINR (e.g., configured by the network entity 105-c), a received signal strength indicator (RSSI) greater than or equal to a threshold RSSI (e.g., configured by the network entity 105-c), or any combination thereof (e.g., a high RSRP/SNR/SINR/RSSI). Conversely, a low geometry UE 115 may be a UE 115 associated with an RSRP less than the threshold RSRP, an SNR less than the threshold SNR, an SINR less than the threshold SINR, an RSSI less than the threshold RSSI, or any combination thereof (e.g., low RSRP/SNR/SINR/RSSI).

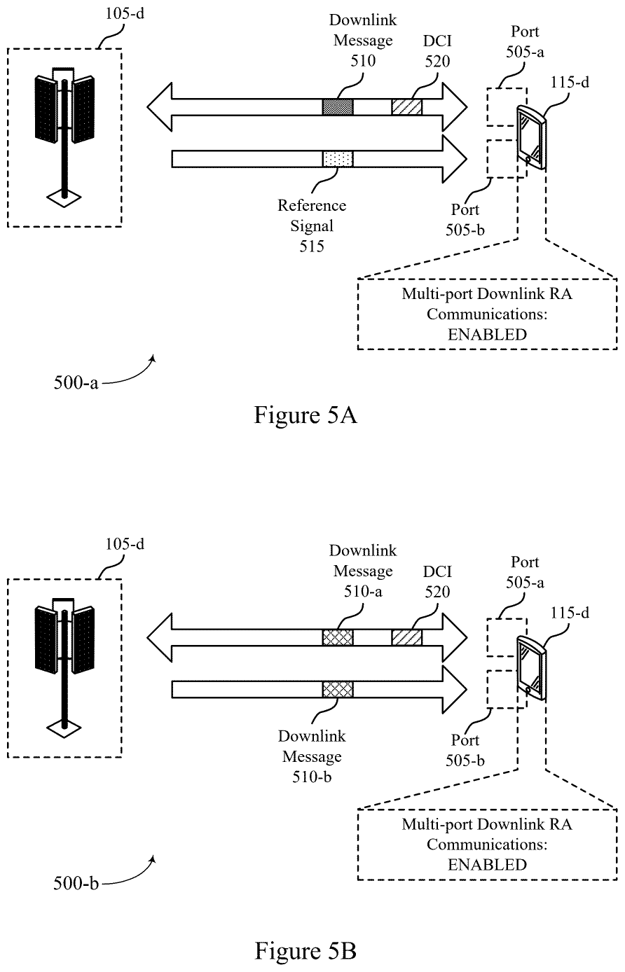

FIGS. 5A and 5B show examples of signaling diagrams 500 (e.g., a signaling diagram 500-a and a signaling diagram 500-b) that supports multi-port communications for downlink broadcast signaling. The signaling diagrams 500 may implement or be implemented by aspects of the wireless communication system 100, the signaling diagrams 200, the signaling diagrams 300, the signaling diagrams 400, or any combination thereof. For example, the signaling diagrams 500 may include one or more UEs 115 (e.g., a UE 115-d), one or more network entities 105 (e.g., a network entity 105-d), or both, which may be examples of the corresponding devices described herein, including with reference to FIG. 1.

In some cases, the multi-port downlink broadcast signal communications, as described with reference to FIG. 2, may be multi-port downlink RA communications, such that the downlink broadcast signal 210-a is a downlink message 510 of a RA procedure (e.g., initial access procedure) and the downlink broadcast signal 210-b is a reference signal 515 (e.g., one or more reference signals 515), as described with reference to the signaling diagram 500-a, or the downlink broadcast signal 210-a is a downlink message 510-a of an RA procedure and the downlink broadcast signal 210-b is a downlink message 510-b of the RA procedure, as described with reference to the signaling diagram 500-b.

For example, in some cases, as depicted in the signaling diagram 500-a, the UE 115-d may receive the downlink message 510 (e.g., msg2, msgB, msg4) of the RA procedure with a multi-port reference signal 515 (e.g., the network entity 105-d includes a multi-port reference signal 515 in the downlink message 510). That is, the UE 115-d may receive the downlink message 510 via a port 505-a and may receive the reference signal 515 via the port 505-b, different from the port 505-a. In some cases, when the network entity 105-d transmits the downlink message 510, which may be msg2 of a RA procedure, the network entity 105-d may enable multi-port reference signals 515 for UEs 115 with group B RA transmissions (e.g., RACH transmissions). In other words, there may be a one-to-one mapping between group B RA and the multi-port downlink message 510 (e.g., transmission of the downlink message 510 and the reference signal 515 on different ports 505). Group A RA may be a first type of RA used by UEs 115 associated with a message size below a threshold size, a message power below a threshold power, or both (e.g., UEs 115 transmitting small amounts of data quickly or with low latency). Conversely, group B RA may be a second type of RA used by UEs 115 associated with a message size above the threshold size, a message power above the threshold power, as a fallback, or any combination thereof (e.g., UEs 115 transmitting longer messages, with more resources, or with more relaxed timing requirements). The use of group A or group B RA by the UE 115-d may be based on one or more configurations (e.g., indicated via SIB2). Additionally, or alternatively, the UE may use a different set of resources to transmit a first message of the RA procedure based on whether the RA procedure is a group A RA or a group B RA. In some cases, a DCI 520 associated with the downlink message 510 (e.g., msg2 DCI) may indicate whether the downlink message 510 is a single-port communication or a multi-port communication. Additionally, or alternatively, the downlink message 510 being a multi-port communication (e.g., multi-port msg2) may trigger reporting (e.g., by the UE 115-d) of an RI, a PMI, or both, via an uplink message of the RA procedure (e.g., msg3).

Additionally, or alternatively, the downlink message 510 may be a msg4 of a RA procedure (e.g., the network entity 105-d includes a multi-port reference signal 515 in msg4). In such cases, the UE 115-d may transmit a report indicating an RI, a PMI, or both, via a feedback message in response to the msg4 (e.g., in addition to feedback, or acknowledgment (ACK), for the msg4). Alternatively, the UE 115-d may include the RI, the PMI, or both, in a report including additional information (e.g., a more detailed report) in a later uplink transmission (e.g., msg5).

In some other cases, as depicted in the signaling diagram 500-b, the UE 115-d may receive a downlink message 510 of an RA procedure (e.g., msg2 PDSCH, msgB PDSCH) via multiple ports 505 (e.g., multi-port downlink message 510, multi-port msgB PDSCH). That is, the UE 115-d may receive the downlink message 510-a (e.g., a first portion of the downlink message 510) via the port 505-a and may receive the downlink message 510-b (e.g., a second portion of the downlink message 510) via the port 505-b, different from the port 505-a. The UE 115-d may receive the multi-port downlink message 510 based on the UE 115-d being an outdoor FWA device. In such cases, the network entity 105-d may identify that the UE 115-d is an FWA device based on an identifier of the UE 115-d transmitted in an uplink message of the RA procedure (e.g., msgA PUSCH). Additionally, or alternative, the UE 115-d may transmit a report indicating an RI, a PMI, or both, via a feedback message in response to the downlink message 510 (e.g., in msgB feedback). Alternatively, the UE 115-d may include the RI, the PMI, or both, in a subsequent uplink transmission.

FIGS. 6A and 6B show examples of resource configurations 600 (e.g., a resource configuration 600-a and a resource configuration 600-b) that support multi-port communications for downlink broadcast signaling. The resource configurations 600 may implement or be implemented by aspects of the wireless communication system 100, the signaling diagrams 200, the signaling diagrams 300, the signaling diagrams 400, the signaling diagrams 500, or any combination thereof. For example, the resource configurations 600 may be implemented by one or more UEs 115, one or more network entities 105, or both, which may be examples of the corresponding devices described herein, including with reference to FIG. 1.

In some cases, a UE may support multi-port communications for broadcast PDSCH. That is, a PDSCH 625 (e.g., paging message 310, SIB message 410, downlink message 510) broadcast by a network entity 105 may include a set of PDSCH symbols 620 (e.g., carrying downlink data) and a DMRS symbol 615 including one or more DMRSs 605, where the one or more DMRSs 605 may support decoding of downlink data included in the PDSCH 625. Accordingly, when multi-port broadcast communications are enabled, the broadcast PDSCH 625 may additionally include (e.g., be transmitted with) one or more reference signals 610 (e.g., other reference signals, multi-port reference signals), different from the one or more DMRSs 605. Thus, the UE 115 may receive, via a first port (e.g., Rx port) of multiple ports of the UE 115, the one or more DMRSs 605 and may receive, via a second port of the multiple ports of the UE 115, the one or more reference signals 610.

In some cases, according to the resource configuration 600-a, the UE 115 may receive the broadcast PDSCH 625 with an additional port in a DMRS symbol 615. For example, communication of the broadcast PDSCH 625 may occur over a set of symbols including one or more DMRS symbols 615 and the set of PDSCH symbols 620. Additionally, in some cases (e.g., when multi-port broadcast PDSCH is enabled), the UE 115 may receive the one or more DMRSs 605 via the first port and may receive the one or more reference signals 610 via the second port, where the one or more DMRSs 605 and the one or more reference signals 610 are received via a DMRS symbol 615 (e.g., of the one or more DMRS symbols 615). The one or more DMRSs 605 and the one or more reference signals 610 may be received via different frequency resources. In such cases, the UE 115 may use the one or more reference signals 610 for channel sounding (e.g., multi-port channel sounding), PDSCH decoding (e.g., decoding of the downlink data), or both.

In some other cases, according to the resource configuration 600-b, the UE 115 may receive the one or more reference signals 610 (e.g., low density reference signals) via a PDSCH symbol 620 (e.g., of the one or more PDSCH symbols 620), in addition to a DMRS symbol 615 (e.g., of the one or more DMRS symbols 615). For example, the UE 115 may receive the one or more DMRSs 605 via the first port (e.g., via the DMRS symbol 615) and may receive one or more reference signals 610 via the second port (e.g., via the PDSCH symbol 620), where the one or more DMRSs 605 and the one or more reference signals 610 are received via the same frequency resources (e.g., and different time resources). In such cases, the UE 115 may use the one or more reference signals 610 for channel sounding, PDSCH decoding (e.g., decoding of the downlink data), or both.

In some cases, the one or more DMRSs 605, the one or more reference signals 610, or both, (e.g., for a broadcast channel) may be communicated in accordance with a signaled power offset with respect to one or more SSBs. The signaled power offset may be a power offset relative to a Tx power used by the network entity 105 to transmit the one or more SSBs. For example, in some cases, the UE 115 may perform one or more first measurements of a downlink broadcast channel based on the one or more DMRSs 605, the one or more reference signals 610, or both, where the one or more first measurements are combined with one or more second measurements of one or more SSBs (e.g., with a signaled power offset). In some other cases, the UE 115 may compare the one or more first measurements with other SSBs from a same or different cells, or with different frequencies, for mobility purposes (e.g., event triggering).

In some examples, the one or more DMRSs 605 may be communicated in accordance with a first power offset with respect to (e.g., relative to) the one or more SSBs and the one or more reference signals 610 may be communicated in accordance with a second power offset with respect to the one or more SSBs, where the first power offset is different from the second power offset and where the first power offset and the second power offset are signaled to the UE 115 (e.g., configured by the network entity). In some cases, the first power offset may be different from the second power offset based on a density of the one or more reference signals 610 being different from a density of the one or more DMRSs 605. Additionally, or alternatively, when the one or more SSBs are received via a single port, the one or more DMRSs 605 may be on a same port as the one or more SSBs, where the one or more DMRSs 605 may be combined with the one or more SBBs (e.g., but the one or more reference signals 610 may not be combined), such that the first power offset is different from the second power offset based on the one or more DMRSs 605 being combined with the one or more SBBs.

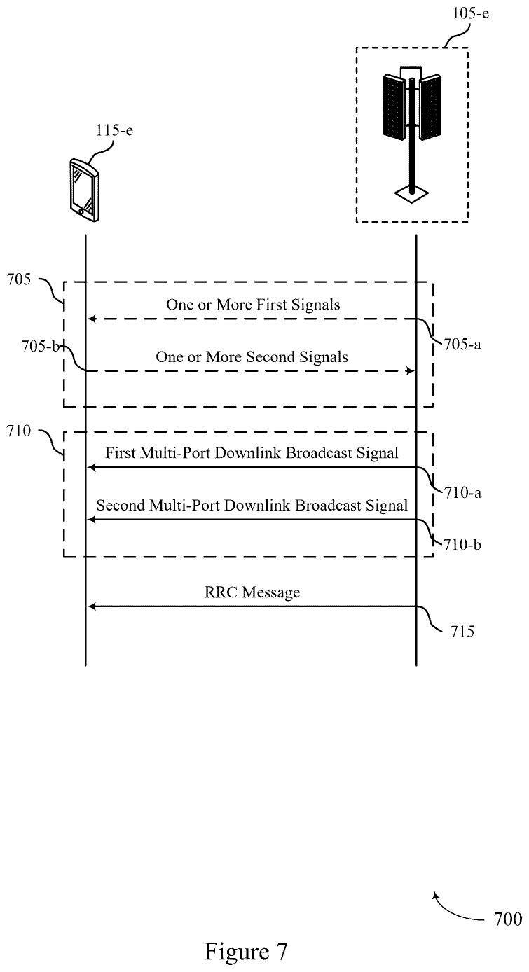

FIG. 7 shows an example of a process flow 700 that supports multi-port communications for downlink broadcast signaling. The process flow 700 may implement or be implemented by aspects of the wireless communication system 100, the signaling diagram 200, the signaling diagrams 300, the signaling diagrams 400, the signaling diagrams 500, the resource configurations 600, or any combination thereof. For example, the process flow 700 may include one or more UEs 115 (e.g., a UE 115-e), one or more network entities 105 (e.g., a network entity 105-e), or both, which may be examples of the corresponding devices described herein, including with reference to FIG. 1.

At 705, the UE 115-e may participate in communication of one or more signals that enable (e.g., explicitly or implicitly) multi-port downlink broadcast signal communications. For example, at 705-a, the UE may receive one or more first signals that enable multi-port downlink broadcast signal communications. Additionally, or alternatively, at 705-b, the UE may transmit one or more second signals that enable multi-port downlink broadcast signal communications.

In some cases, the one or more first signals may include first configuration information indicative of a paging type of a PO, where the paging type is indicative of multi-port paging such that the multi-port downlink broadcast signal communications are enabled in accordance with the paging type being multi-port paging. Additionally, or alternatively, the one or more first signals may include a first control message associated with a first paging message, where the first control message indicates a paging type of the first paging message is multi-port paging such that the multi-port downlink broadcast signal communications are enabled in accordance with the paging type being multi-port paging. Additionally, or alternatively, the one or more first signals may include a PEI for the first paging message, where the PEI indicates the paging type of the first paging message is multi-port paging such that the multi-port downlink broadcast signal communications are enabled in accordance with the paging type being multi-port paging.

Additionally, or alternatively, the one or more first signals may include second configuration information that indicates on-demand SIB messages are associated with multi-port communications and indicates periodic SIB messages are associated with single-port communications, where the multi-port downlink broadcast signal communications are enabled in accordance with the first SIB message being a first on-demand SIB message. Additionally, or alternatively, the one or more first signals may include a second control message that schedules the first SIB message, where the second control message indicates a SIB transmission type of the first SIB message is multi-port, such that that the multi-port downlink broadcast signal communications are enabled in accordance with the SIB transmission type being multi-port. Additionally, or alternatively, the one or more second signals may include a request message indicative of a SIB transmission type for the first SIB message, where the multi-port downlink broadcast signal communications are enabled in accordance with the requested SIB transmission type being multi-port.

Additionally, or alternatively, the one or more second signals may include a first uplink message of a RA procedure transmitted via a first set of resources, where the first set of resources corresponds to a first type of RA procedure from multiple types of random access procedures, where the multi-port downlink broadcast signal communications are enabled in accordance with the first type of random access procedure enabling multi-port transmissions. Additionally, or alternatively, the one or more first signals may include a third control message associated with a downlink message of the RA procedure, where the control message indicates a transmission type of the downlink message of the RA procedure is multi-port, such that the multi-port downlink broadcast signal communications are enabled in accordance with the transmission type being multi-port.

At 710, the UE 115-e may receive the multi-port downlink broadcast signal communications. For example, at 710-a, the UE 115-e may receive, via a first port of multiple ports of the UE 115-e and based on enablement of the multi-port downlink broadcast signal communications, a first downlink broadcast signal from the network entity 105-e. Additionally, at 710-b, the UE 115-e may receive, via a second port of the multiple ports of the UE 115-e and based on enablement of the multi-port downlink broadcast signal communications, a second downlink broadcast signal from the network entity 105-e, where the first port is different from the second port. Additionally, the first downlink broadcast signal and the second downlink broadcast signal may be received prior to reception, from the network entity 105-e at 715, of an RRC message that indicates first configuration information for the UE 115-e.

In some cases, the first downlink broadcast signal may include the first paging message and the second downlink broadcast signal may include a downlink reference signal or a second paging message. In some examples, multi-rank uplink transmissions may be enabled during an RA procedure in accordance with enablement of the multi-port downlink broadcast signal communications and based on the second downlink broadcast signal including the downlink reference signal. Additionally, or alternatively, the first paging message may be associated with one or more first symbols in a PDCCH and one or more second symbols in a PDSCH, where the first paging message is received via the one or more first symbols in the PDCCH, and the second downlink broadcast signal includes the downlink reference signal received via the one or more second symbols in the PDSCH. Additionally, or alternatively, the first paging message may include control information, and the second downlink broadcast signal may include the second paging message that further includes data associated with the first paging message.

In some other cases, the first downlink broadcast signal may include the first SIB message, and the second downlink broadcast signal may include a second SIB message or a downlink reference signal.

In some other cases, the first downlink broadcast signal may include the downlink message of an RA procedure, and the second downlink broadcast signal may include a second SIB message or a downlink reference signal or a downlink data message associated with the downlink message of the RA procedure.

Additionally, or alternatively, the first downlink broadcast signal may include a DMRS, and the second downlink broadcast signal may include another downlink reference signal. In such cases, the DMRS may be associated with a first power offset relative to an SSB, and the other downlink reference signal may be associated with a second power offset relative to the SSB, the second power offset different from the first power offset.

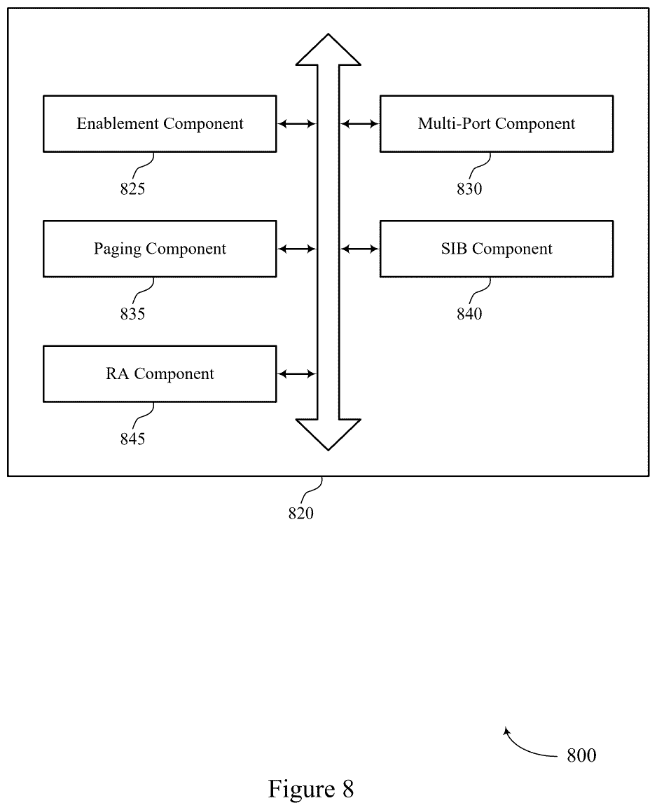

FIG. 8 shows an example 800 of a processing system 820 that supports multi-port communications for downlink broadcast signaling. A processing system 820 may be an example of a processing system 140 (such as of a UE 115) and may include an enablement component 825, a multi-port component 830, a paging component 835, an SIB component 840, a RA component 845, or any combination thereof. A processing system 820, or various component thereof, may be an example of means for performing (such as a means for causing a UE 115 to perform) various techniques described herein.

The enablement component 825 may be configured to cause the UE 115 to participate in communication of one or more signals that enable multi-port downlink broadcast signal communications. The multi-port component 830 may be configured to cause the UE 115 to receive, via a first port of a set of multiple ports of the UE and based on enablement of the multi-port downlink broadcast signal communications, a first downlink broadcast signal from a network entity. In some examples, the multi-port component 830 may be configured to cause the UE 115 to receive, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of an RRC message that indicates first configuration information for the UE.

In some examples, the first downlink broadcast signal includes a first paging message.

In some examples, the second downlink broadcast signal includes a downlink reference signal or a second paging message.

In some examples, to support participating in communication of the one or more signals that enable the multi-port downlink broadcast signal communications, the paging component 835 may be configured to cause the UE 115 to receive second configuration information indicative of a paging type of a PO, where the paging type is indicative of multi-port paging.

In some examples, the first downlink broadcast signal and the second downlink broadcast signal are received via different ports during the PO in accordance with the paging type.

In some examples, to support participating in communication of the one or more signals that enable the multi-port downlink broadcast signal communications, the paging component 835 may be configured to cause the UE 115 to receive a control message associated with the first paging message, where the control message indicates a paging type of the first paging message.

In some examples, the paging type is indicative of multi-port paging.

In some examples, the first downlink broadcast signal and the second downlink broadcast signal are received via different ports in accordance with the paging type.

In some examples, to support participating in communication of the one or more signals that enable the multi-port downlink broadcast signal communications, the paging component 835 may be configured to cause the UE 115 to receive a PEI for the first paging message, where the PEI indicates a paging type of the first paging message.

In some examples, the paging type is indicative of multi-port paging.

In some examples, the first downlink broadcast signal and the second downlink broadcast signal are received via different ports in accordance with the paging type.

In some examples, multi-rank uplink transmissions are enabled during a RA procedure in accordance with enablement of the multi-port downlink broadcast signal communications and based on the second downlink broadcast signal including a downlink reference signal.

In some examples, the first paging message is associated with one or more first symbols in a downlink control channel and one or more second symbols in a downlink shared channel.

In some examples, the first paging message is received via the one or more first symbols in the downlink control channel.

In some examples, the second downlink broadcast signal includes a downlink reference signal received via the one or more second symbols in the downlink shared channel.

In some examples, the first paging message includes a first portion of a paging data message. In some examples, the second downlink broadcast signal includes a second paging message that further includes a second portion of the paging data message.

In some examples, the first downlink broadcast signal includes a first SIB message.

In some examples, the second downlink broadcast signal includes a second SIB message or a downlink reference signal.

In some examples, to support participating in communication of the one or more signals that enable the multi-port downlink broadcast signal communications, the SIB component 840 may be configured to cause the UE 115 to receive configuration information that indicates on-demand SIB messages are associated with multi-port communications and indicates periodic SIB messages are associated with single-port communications.

In some examples, the first SIB message is a first on-demand SIB message.

In some examples, the first downlink broadcast signal and the second downlink broadcast signal are received via different ports in accordance with the first on-demand SIB message.

In some examples, to support participating in communication of the one or more signals that enable the multi-port downlink broadcast signal communications, the SIB component 840 may be configured to cause the UE 115 to receive a control message that schedules the first SIB message, where the control message indicates a SIB transmission type of the first SIB message.

In some examples, the SIB transmission type is indicative of multi-port communications.

In some examples, the first downlink broadcast signal and the second downlink broadcast signal are received via different ports in accordance with the SIB transmission type.

In some examples, to support participating in communication of the one or more signals that enable the multi-port downlink broadcast signal communications, the SIB component 840 may be configured to cause the UE 115 to transmit a request message indicative of a SIB transmission type for the first SIB message.

In some examples, the requested SIB transmission type is indicative of multi-port communications.

In some examples, the first downlink broadcast signal and the second downlink broadcast signal are received via different ports in accordance with the requested SIB transmission type.

In some examples, the request message includes an uplink WUS.

In some examples, the first SIB message includes control information. In some examples, the second downlink broadcast signal includes a second SIB message that further includes data associated with the first SIB message.

In some examples, the first downlink broadcast signal includes a downlink message of a RA procedure.

In some examples, the second downlink broadcast signal includes a downlink reference signal or a downlink data message associated with the downlink message of the RA procedure.

In some examples, to support participating in communication of the one or more signals that enable the multi-port downlink broadcast signal communications, the RA component 845 may be configured to cause the UE 115 to transmit a first uplink message of the RA procedure via a first set of resources, where the first set of resources corresponds to a first type of RA procedure from a set of multiple types of RA procedures.

In some examples, the first type of RA procedure enables multi-port transmissions.

In some examples, the first downlink message of the RA procedure and the second downlink broadcast signal are received via different ports in accordance with enablement of multi-port communications based on the first type of RA procedure.

In some examples, to support participating in communication of the one or more signals that enable the multi-port downlink broadcast signal communications, the RA component 845 may be configured to cause the UE 115 to receive a control message associated with the first downlink message of the RA procedure, where the control message indicates a transmission type of the first downlink message of the RA procedure.

In some examples, the transmission type is indicative of multi-port communications.

In some examples, the first downlink message of the RA procedure and the second downlink broadcast signal are received via different ports in accordance with the transmission type.

In some examples, the downlink message includes a first downlink message of the RA procedure, and the RA component 845 may be configured to cause the UE 115 to transmit, via a second uplink message of the RA procedure, a report indicative of a rank indicator, a PMI, or both, in response to reception of the first downlink message of the RA procedure and the second downlink broadcast signal via different ports.

In some examples, the downlink message includes a second downlink message of the RA procedure, and the RA component 845 may be configured to cause the UE 115 to transmit, via a feedback message in response to the second downlink message of the RA procedure or via another uplink message, a report indicative of a rank indicator, a PMI, or both, in response to reception of the second downlink message of the RA procedure and the second downlink broadcast signal via different ports.

In some examples, the first downlink broadcast signal includes a DMRS. In some examples, the second downlink broadcast signal includes another downlink reference signal.

In some examples, the DMRS and the downlink reference signal are received via a same set of resources in a time domain or a same set of resources in a frequency domain.

In some examples, the DMRS is associated with a first power offset relative to an SSB.

In some examples, the downlink reference signal is associated with a second power offset relative to the SSB, the second power offset different from the first power offset.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for multi-port communications for downlink broadcast signaling, which may result in improved communication reliability, reduced latency, improved user experience related to reduced processing, reduced power consumption, more efficient utilization of communication resources, improved coordination between devices, longer battery life, and improved utilization of processing capability, among other advantages.

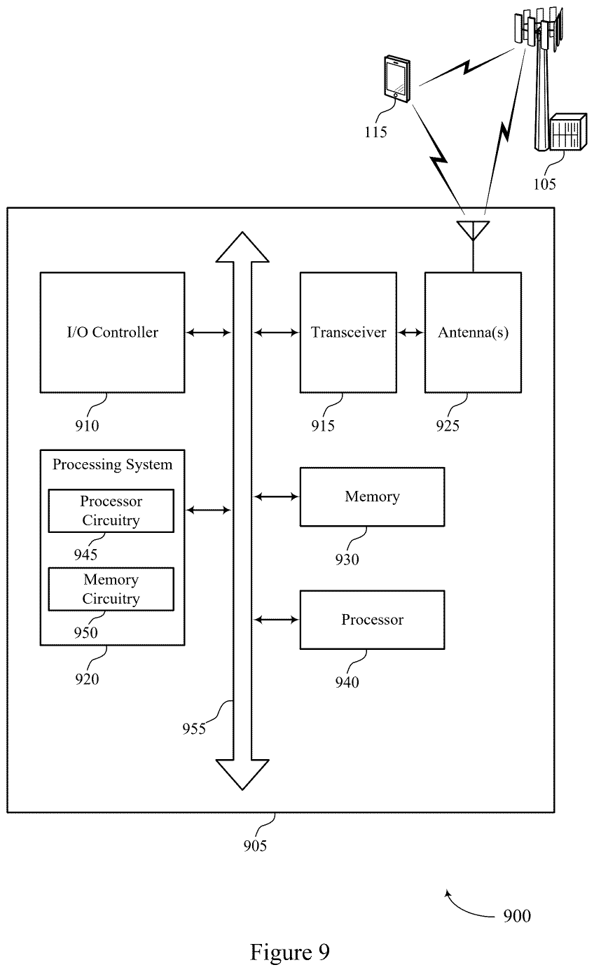

FIG. 9 shows an example of a system 900 including a device 905 that supports multi-port communications for downlink broadcast signaling. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 820. For example, the processing system 920 may include processor circuitry 945 and memory circuitry 950 that stores code, and may be configured to cause the device 905 to perform operations that support multi-port communications for downlink broadcast signaling. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for multi-port communications for downlink broadcast signaling, which may result in improved communication reliability, reduced latency, improved user experience related to reduced processing, reduced power consumption, more efficient utilization of communication resources, improved coordination between devices, longer battery life, and improved utilization of processing capability, among other advantages.

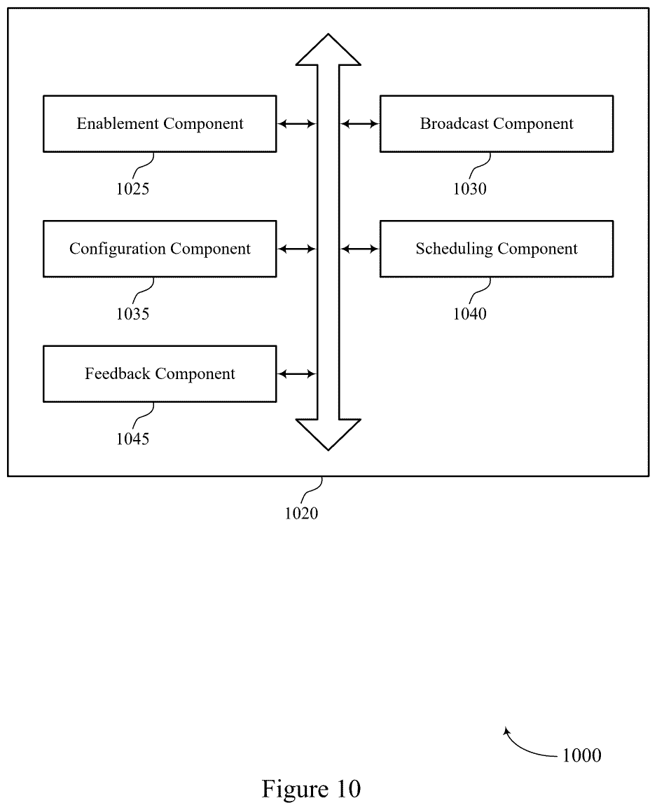

FIG. 10 shows an example 1000 of a processing system 1020 that supports multi-port communications for downlink broadcast signaling. A processing system 1020 may be an example of a processing system 145 (such as network entity 105) and may include an enablement component 1025, a broadcast component 1030, a configuration component 1035, a scheduling component 1040, a feedback component 1045, or any combination thereof. A processing system 1020, or various component thereof, may be an example of means for performing (such as a means for causing a network entity 105 to perform) various techniques described herein.

The enablement component 1025 may be configured to cause the network entity 105 to participate in communication of one or more signals that enable multi-port downlink broadcast signal communications. The broadcast component 1030 may be configured to cause the network entity 105 to output, based on enablement of the multi-port downlink broadcast signal communications, a first downlink broadcast signal for a UE. In some examples, the broadcast component 1030 may be configured to cause the network entity 105 to output, based on enablement of the multi-port downlink broadcast signal communications, a second downlink broadcast signal for the UE, where the first downlink broadcast signal and the second downlink broadcast signal are obtained prior to output, for the UE, of an RRC message indicative of first configuration information for the UE.

In some examples, the first downlink broadcast signal includes a first paging message.

In some examples, the second downlink broadcast signal includes a downlink reference signal or a second paging message.

In some examples, to support participating in communication of the one or more signals that enable the multi-port downlink broadcast signal communications, the configuration component 1035 may be configured to cause the network entity 105 to output second configuration information indicative of a paging type of a PO.

In some examples, the paging type is indicative of multi-port paging.

In some examples, the multi-port downlink broadcast signal communications are enabled in accordance with the paging type.

In some examples, to support participating in communication of the one or more signals that enable the multi-port downlink broadcast signal communications, the configuration component 1035 may be configured to cause the network entity 105 to output a control message associated with the first paging message, where the control message indicates a paging type of the first paging message.

In some examples, the paging type is indicative of multi-port paging.

In some examples, the multi-port downlink broadcast signal communications are enabled in accordance with the paging type.

In some examples, to support participating in communication of the one or more signals that enable the multi-port downlink broadcast signal communications, the broadcast component 1030 may be configured to cause the network entity 105 to output a PEI for the first paging message, where the PEI indicates a paging type of the first paging message.

In some examples, the paging type is indicative of multi-port paging.

In some examples, the multi-port downlink broadcast signal communications are enabled in accordance with the paging type.

In some examples, multi-rank uplink communications are enabled during a RA procedure in accordance with enablement of the multi-port downlink broadcast signal communications and based on the second downlink broadcast signal including a downlink reference signal.

In some examples, the first paging message is associated with one or more first symbols in a downlink control channel and one or more second symbols in a downlink shared channel.

In some examples, the first paging message is output via the one or more first symbols in the downlink control channel.

In some examples, the second downlink broadcast signal includes a downlink reference signal output via the one or more second symbols in the downlink shared channel.

In some examples, the first paging message includes a first portion of a paging data message.

In some examples, the second downlink broadcast signal includes a second paging message that further includes a second portion of the paging data message.

In some examples, the first downlink broadcast signal includes a first SIB message.

In some examples, the second downlink broadcast signal includes a second SIB message or a downlink reference signal.

In some examples, to support participating in communication of the one or more signals that enable the multi-port downlink broadcast signal communications, the configuration component 1035 may be configured to cause the network entity 105 to output configuration information that indicates on-demand SIB messages are associated with multi-port communications and indicates periodic SIB messages are associated with single-port communications.

In some examples, the first SIB message is a first on-demand SIB message.

In some examples, the first downlink broadcast signal and the second downlink broadcast signal are received via different ports in accordance with the first on-demand SIB message.

In some examples, to support participating in communication of the one or more signals that enable the multi-port downlink broadcast signal communications, the scheduling component 1040 may be configured to cause the network entity 105 to output a control message that schedules the first SIB message, where the control message indicates a SIB transmission type of the first SIB message.

In some examples, the SIB transmission type is indicative of multi-port communications.

In some examples, the multi-port downlink broadcast signal communications are enabled in accordance with the SIB transmission type.

In some examples, to support participating in communication of the one or more signals that enable the multi-port downlink broadcast signal communications, the feedback component 1045 may be configured to cause the network entity 105 to obtain a request message indicative of a SIB transmission type for the first SIB message.

In some examples, the requested SIB transmission type is indicative of multi-port communications.

In some examples, the multi-port downlink broadcast signal communications are enabled in accordance with the requested SIB transmission type.

In some examples, the request message includes an uplink WUS.

In some examples, the first SIB message includes control information. In some examples, the second downlink broadcast signal includes a second SIB message that further includes data associated with the first SIB message.

In some examples, the first downlink broadcast signal includes a downlink message of a RA procedure.

In some examples, the second downlink broadcast signal includes a downlink reference signal or a downlink data message associated with the downlink message of the RA procedure.

In some examples, to support participating in communication of the one or more signals that enable the multi-port downlink broadcast signal communications, the broadcast component 1030 may be configured to cause the network entity 105 to obtain a first uplink message of the RA procedure via a first set of resources.

In some examples, the first set of resources corresponds to a first type of RA procedure from a set of multiple types of RA procedures.

In some examples, the first type of RA procedure enables multi-port transmissions.

In some examples, the multi-port downlink broadcast signal communications are enabled in accordance with the first type of RA procedure.

In some examples, to support participating in communication of the one or more signals that enable the multi-port downlink broadcast signal communications, the configuration component 1035 may be configured to cause the network entity 105 to output a control message associated with the first downlink message of the RA procedure, where the control message indicates a transmission type of the first downlink message of the RA procedure.

In some examples, the transmission type is indicative of multi-port communications.

In some examples, the multi-port downlink broadcast signal communications are enabled in accordance with the transmission type.

In some examples, the downlink message includes a first downlink message of the RA procedure, and the feedback component 1045 may be configured to cause the network entity 105 to obtain, via a second uplink message of the RA procedure, a report indicative of a rank indicator, a PMI, or both, in response to enablement of the multi-port downlink broadcast signal communications.

In some examples, the downlink message includes a second downlink message of the RA procedure, and the feedback component 1045 may be configured to cause the network entity 105 to obtain, via a feedback message in response to the second downlink message of the RA procedure or via another uplink message, a report indicative of a rank indicator, a PMI, or both, in response to enablement of the multi-port downlink broadcast signal communications.

In some examples, the first downlink broadcast signal includes a DMRS. In some examples, the second downlink broadcast signal includes another downlink reference signal.

In some examples, the DMRS and the downlink reference signal are outputted via a same set of resources in a time domain or a same set of resources in a frequency domain.

In some examples, the DMRS is associated with a first power offset relative to an SSB.

In some examples, the downlink reference signal is associated with a second power offset relative to the SSB, the second power offset different from the first power offset.

A processing system 1020 may include or be an example of one or more chips, SoCs, chipsets, packages, components, or devices that individually or collectively constitute or include a processing system. A processing system 1020 may interface with other components of a network entity 105. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a network entity 105). Operations described herein with reference to the processing system 1020, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1020 for operation in a processing system 1020 as described herein, the processing system 1020 may support techniques for multi-port communications for downlink broadcast signaling, which may result in improved communication reliability, reduced latency, improved user experience related to reduced processing, reduced power consumption, more efficient utilization of communication resources, improved coordination between devices, longer battery life, and improved utilization of processing capability, among other advantages.

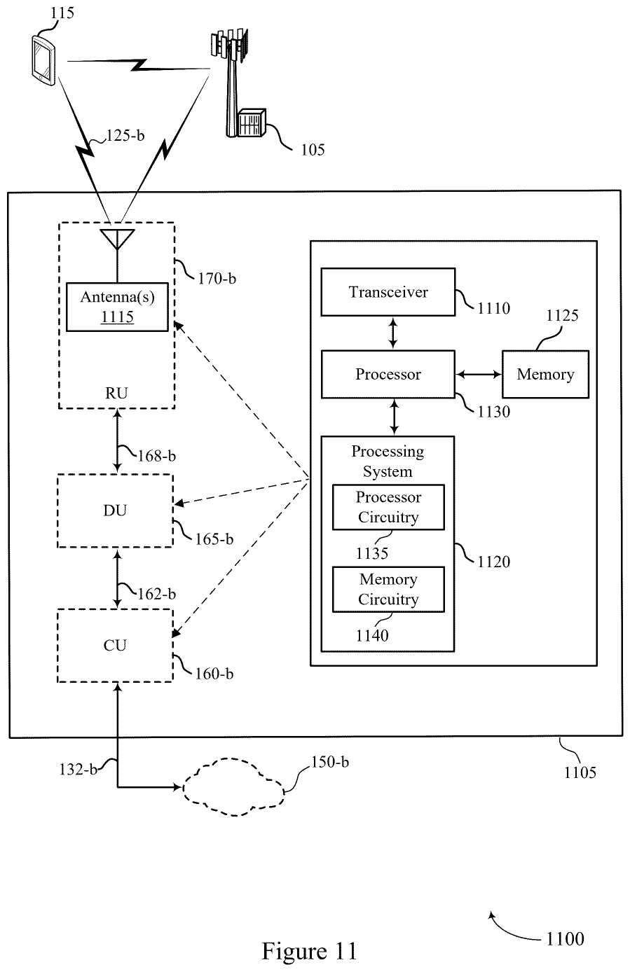

FIG. 11 shows an example of a system 1100 including a device 1105 that supports multi-port communications for downlink broadcast signaling. The device 1105 may communicate (such as via one or more wired interfaces or one or more wireless interfaces) with other network devices or network equipment such as a core network 150-b, other network entities 105, UEs 115, or any combination thereof. The device 1105 may include components for transmitting and receiving communication, which may include a processing system 1120, a transceiver 1110, antenna(s) 1115, a memory 1125, and a processor 1130. Components of the device 1105 may be coupled (such as operatively, communicatively, functionally, electronically, electrically, in electronic communication) via one or more interfaces.

The transceiver 1110 may communicate bi-directionally with another transceiver via wired or wireless links, and may support transmission operations, reception operations, or both, as described herein. The transceiver 1110 may include a modem to modulate and demodulate signals, to provide the modulated signals for transmission (such as via antenna(s) 1115, via a wired interface), and to demodulate received signals (such as received via antenna(s) 1115, received via a wired interface). The transceiver 1110 may be operable to support communication via one or more communication links (such as a communication link 125-b, a backhaul link 132-b, a midhaul link 162-b, fronthaul link 168-b).

The processor 1130 may be a general-purpose processing component that supports various operations (such as applications) of the device 1105. The memory 1125 may be a general-purpose storage component that stores code executable by the processor 1130. Such code may include instructions that, when executed by the processor 1130, cause the device 1105 to perform various functions (such as to support an application of the device 1105).

For examples in which the device 1105 is a network entity 105 in a disaggregated architecture, one or more components of the device 1105 may be located at one or more of a CU 160-b, a DU 165-b, or an RU 170-b, one or more of which may include aspects of the processing system 1120, the processor 1130, the memory 1125, or the transceiver 1110. Functions of the device 1105 may be performed at different components or an operation may be divided between different components (such as different functions being supported by aspects of the CU 160-b, the DU 165-b, or the RU 170-b, the transceiver 1110, the processor 1130, the memory 1125, the processing system 1120, or any combination thereof). For example, the processing system 1120 may be a component of one or more of the CU 160-b, the DU 165-b, or the RU 170-b. In some examples, interfaces between components of device 1105 (such as CU 160-b, DU 165-b, RU 170-b) may support communication at a protocol layer or between protocol layers of a protocol stack.

In some examples, the processing system 1120 may manage aspects of communication with the core network 150-b (such as via a backhaul link 132). For example, the processing system 1120 may manage the transfer of data communication for UEs 115 with a gateway of the core network 150-b. In some examples, the processing system 1120 may manage communication with one or more other network entities 105 and may include a controller or scheduler for controlling communication with UEs 115 (such as in cooperation with the one or more other network entities 105). In some examples, the processing system 1120 may support an interface (such as X2 interface, Xn interface) to provide communication between network entities 105.

The processing system 1120 may be an example of a processing system 145 or a processing system 1020. For example, the processing system 1120 may include processor circuitry 1135 and memory circuitry 1140 that stores code, and the processing system 1120 may be configured to cause the device 1105 to perform operations that support multi-port communications for downlink broadcast signaling. Although the processing system 1120 is illustrated as a separate component, which may involve a separate chip, chipset, or other module, in some implementations, one or more functions described with reference to the processing system 1120 may be supported by or performed by a transceiver 1110, antenna(s) 1115, a processor 1130, memory 1125, or any combination thereof, such that a processing system 1120 may include one or more of a transceiver 1110, antenna(s) 1115, a processor 1130, memory 1125, or any combination thereof. Further, processor circuitry 1135 and memory circuitry 1140 each may be implemented at the device 1105 in accordance with an aggregated architecture, or the processor circuitry 1135 and the memory circuitry 1140 may be implemented at one or more of a CU 160-b, a DU 165-b, or an RU 170-b in accordance with a disaggregated architecture.

By including or configuring the processing system 1120 for operation in the device 1105 as described herein, may support techniques for multi-port communications for downlink broadcast signaling, which may result in improved communication reliability, reduced latency, improved user experience related to reduced processing, reduced power consumption, more efficient utilization of communication resources, improved coordination between devices, longer battery life, improved utilization of processing capability, among other advantages.

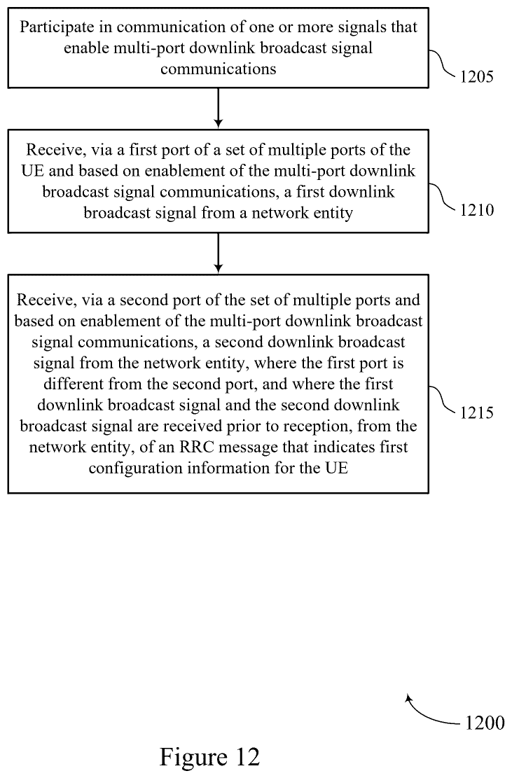

FIG. 12 shows an example of a method 1200 that supports multi-port communications for downlink broadcast signaling. Operations of the method 1200 may be performed by a UE or its components (such as using a processing system configured to cause the UE 115 to perform one or more of the operations) as described herein.

At 1205, the method may include participating in communication of one or more signals that enable multi-port downlink broadcast signal communications. In some examples, aspects of the operations of 1205 may be performed by an enablement component 825.

At 1210, the method may include receiving, via a first port of a set of multiple ports of the UE and based on enablement of the multi-port downlink broadcast signal communications, a first downlink broadcast signal from a network entity. In some examples, aspects of the operations of 1210 may be performed by a multi-port component 830.

At 1215, the method may include receiving, via a second port of the set of multiple ports and based on enablement of the multi-port downlink broadcast signal communications, a second downlink broadcast signal from the network entity, where the first port is different from the second port, and where the first downlink broadcast signal and the second downlink broadcast signal are received prior to reception, from the network entity, of an RRC message that indicates first configuration information for the UE. In some examples, aspects of the operations of 1215 may be performed by a multi-port component 830.

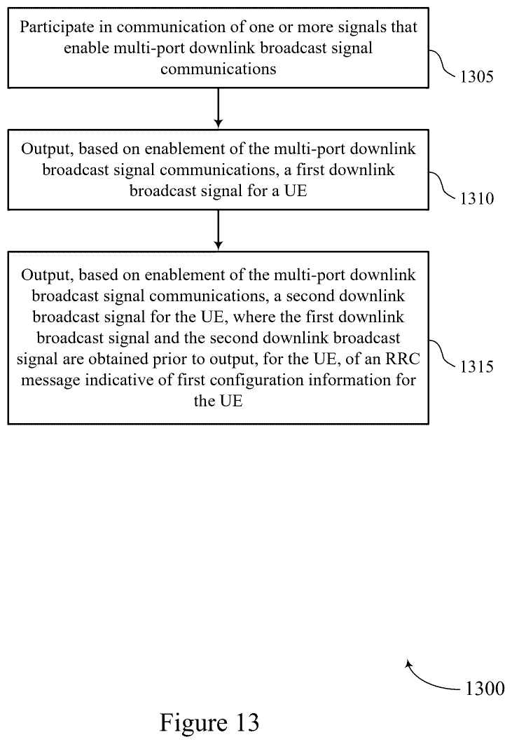

FIG. 13 shows an example of a method 1300 that supports multi-port communications for downlink broadcast signaling. Operations of the method 1300 may be performed by a network entity 105 or its components (such as using a processing system configured to cause the network entity to perform one or more operations) as described herein.

At 1305, the method may include participating in communication of one or more signals that enable multi-port downlink broadcast signal communications. In some examples, aspects of the operations of 1305 may be performed by an enablement component 1025.

At 1310, the method may include outputting, based on enablement of the multi-port downlink broadcast signal communications, a first downlink broadcast signal for a UE. In some examples, aspects of the operations of 1310 may be performed by a broadcast component 1030.

At 1315, the method may include outputting, based on enablement of the multi-port downlink broadcast signal communications, a second downlink broadcast signal for the UE, where the first downlink broadcast signal and the second downlink broadcast signal are obtained prior to output, for the UE, of an RRC message indicative of first configuration information for the UE. In some examples, aspects of the operations of 1315 may be performed by a broadcast component 1030.

Implementation examples are described in the following numbered clauses:

Aspect 1: A method for wireless communication at a UE, comprising: participating in communication of one or more signals that enable multi-port downlink broadcast signal communications; receiving, via a first port of a plurality of ports of the UE and based at least in part on enablement of the multi-port downlink broadcast signal communications, a first downlink broadcast signal from a network entity; and receiving, via a second port of the plurality of ports and based at least in part on enablement of the multi-port downlink broadcast signal communications, a second downlink broadcast signal from the network entity, wherein the first port is different from the second port, and wherein the first downlink broadcast signal and the second downlink broadcast signal are received prior to reception, from the network entity, of an RRC message that indicates first configuration information for the UE.

Aspect 2: The method of aspect 1, wherein the first downlink broadcast signal comprises a first paging message.

Aspect 3: The method of aspect 2, wherein the second downlink broadcast signal comprises a downlink reference signal or a second paging message.

Aspect 4: The method of any of aspects 2 through 3, wherein participating in communication of the one or more signals that enable the multi-port downlink broadcast signal communications comprises: receiving second configuration information indicative of a paging type of a PO, wherein the paging type is indicative of multi-port paging.

Aspect 5: The method of aspect 4, wherein the first downlink broadcast signal and the second downlink broadcast signal are received via different ports during the PO in accordance with the paging type.

Aspect 6: The method of any of aspects 2 through 5, wherein participating in communication of the one or more signals that enable the multi-port downlink broadcast signal communications comprises: receiving a control message associated with the first paging message, wherein the control message indicates a paging type of the first paging message.

Aspect 7: The method of aspect 6, wherein the paging type is indicative of multi-port paging.

Aspect 8: The method of any of aspects 6 through 7, wherein the first downlink broadcast signal and the second downlink broadcast signal are received via different ports in accordance with the paging type.

Aspect 9: The method of any of aspects 2 through 8, wherein participating in communication of the one or more signals that enable the multi-port downlink broadcast signal communications comprises: receiving a PEI for the first paging message, wherein the PEI indicates a paging type of the first paging message.

Aspect 10: The method of aspect 9, wherein the paging type is indicative of multi-port paging.

Aspect 11: The method of any of aspects 9 through 10, wherein the first downlink broadcast signal and the second downlink broadcast signal are received via different ports in accordance with the paging type.

Aspect 12: The method of any of aspects 2 through 11, wherein multi-rank uplink transmissions are enabled during a RA procedure in accordance with enablement of the multi-port downlink broadcast signal communications and based at least in part on the second downlink broadcast signal comprising a downlink reference signal.

Aspect 13: The method of any of aspects 2 through 12, wherein the first paging message is associated with one or more first symbols in a downlink control channel and one or more second symbols in a downlink shared channel.

Aspect 14: The method of aspect 13, wherein the first paging message is received via the one or more first symbols in the downlink control channel.

Aspect 15: The method of any of aspects 13 through 14, wherein the second downlink broadcast signal comprises a downlink reference signal received via the one or more second symbols in the downlink shared channel.

Aspect 16: The method of any of aspects 2 through 15, wherein the first paging message comprises a first portion of a paging data message, and the second downlink broadcast signal comprises a second paging message that further comprises a second portion of the paging data message.

Aspect 17: The method of any of aspects 1 through 16, wherein the first downlink broadcast signal comprises a first SIB message.

Aspect 18: The method of aspect 17, wherein the second downlink broadcast signal comprises a second SIB message or a downlink reference signal.

Aspect 19: The method of any of aspects 17 through 18, wherein participating in communication of the one or more signals that enable the multi-port downlink broadcast signal communications comprises: receiving configuration information that indicates on-demand SIB messages are associated with multi-port communications and indicates periodic SIB messages are associated with single-port communications.

Aspect 20: The method of aspect 19, wherein the first SIB message is a first on-demand SIB message.

Aspect 21: The method of aspect 20, wherein the first downlink broadcast signal and the second downlink broadcast signal are received via different ports in accordance with the first on-demand SIB message.

Aspect 22: The method of any of aspects 17 through 21, wherein participating in communication of the one or more signals that enable the multi-port downlink broadcast signal communications comprises: receiving a control message that schedules the first SIB message, wherein the control message indicates a SIB transmission type of the first SIB message.

Aspect 23: The method of aspect 22, wherein the SIB transmission type is indicative of multi-port communications.

Aspect 24: The method of any of aspects 22 through 23, wherein the first downlink broadcast signal and the second downlink broadcast signal are received via different ports in accordance with the SIB transmission type.

Aspect 25: The method of any of aspects 17 through 24, wherein participating in communication of the one or more signals that enable the multi-port downlink broadcast signal communications comprises: transmitting a request message indicative of a SIB transmission type for the first SIB message.

Aspect 26: The method of aspect 25, wherein the requested SIB transmission type is indicative of multi-port communications.

Aspect 27: The method of any of aspects 25 through 26, wherein the first downlink broadcast signal and the second downlink broadcast signal are received via different ports in accordance with the requested SIB transmission type.

Aspect 28: The method of any of aspects 25 through 27, wherein the request message comprises an uplink WUS.

Aspect 29: The method of any of aspects 17 through 28, wherein the first SIB message comprises control information, and the second downlink broadcast signal comprises a second SIB message that further comprises data associated with the first SIB message.

Aspect 30: The method of any of aspects 1 through 29, wherein the first downlink broadcast signal comprises a downlink message of a RA procedure.

Aspect 31: The method of aspect 30, wherein the second downlink broadcast signal comprises a downlink reference signal or a downlink data message associated with the downlink message of the RA procedure.

Aspect 32: The method of any of aspects 30 through 31, wherein the downlink message comprises a first downlink message of the RA procedure, and wherein participating in communication of the one or more signals that enable the multi-port downlink broadcast signal communications comprises: transmitting a first uplink message of the RA procedure via a first set of resources, wherein the first set of resources corresponds to a first type of RA procedure from a plurality of types of RA procedures.

Aspect 33: The method of aspect 32, wherein the first type of RA procedure enables multi-port transmissions.

Aspect 34: The method of aspect 33, wherein the first downlink message of the RA procedure and the second downlink broadcast signal are received via different ports in accordance with enablement of multi-port communications based at least in part on the first type of RA procedure.

Aspect 35: The method of any of aspects 30 through 34, wherein the downlink message comprises a first downlink message of the RA procedure, and wherein participating in communication of the one or more signals that enable the multi-port downlink broadcast signal communications comprises: receiving a control message associated with the first downlink message of the RA procedure, wherein the control message indicates a transmission type of the first downlink message of the RA procedure.

Aspect 36: The method of aspect 35, wherein the transmission type is indicative of multi-port communications.

Aspect 37: The method of any of aspects 35 through 36, wherein the first downlink message of the RA procedure and the second downlink broadcast signal are received via different ports in accordance with the transmission type.

Aspect 38: The method of any of aspects 30 through 37, wherein the downlink message comprises a first downlink message of the RA procedure, the method further comprising: transmitting, via a second uplink message of the RA procedure, a report indicative of a rank indicator, a PMI, or both, in response to reception of the first downlink message of the RA procedure and the second downlink broadcast signal via different ports.

Aspect 39: The method of any of aspects 30 through 38, wherein the downlink message comprises a second downlink message of the RA procedure, the method further comprising: transmitting, via a feedback message in response to the second downlink message of the RA procedure or via another uplink message, a report indicative of a rank indicator, a PMI, or both, in response to reception of the second downlink message of the RA procedure and the second downlink broadcast signal via different ports.

Aspect 40: The method of any of aspects 1 through 39, wherein the first downlink broadcast signal comprises a DMRS, and the second downlink broadcast signal comprises another downlink reference signal.

Aspect 41: The method of aspect 40, wherein the DMRS and the downlink reference signal are received via a same set of resources in a time domain or a same set of resources in a frequency domain.

Aspect 42: The method of any of aspects 40 through 41, wherein the DMRS is associated with a first power offset relative to a SSB.

Aspect 43: The method of aspect 42, wherein the downlink reference signal is associated with a second power offset relative to the SSB, the second power offset different from the first power offset.

Aspect 44: A method for wireless communications at a network entity, comprising: participating in communication of one or more signals that enable multi-port downlink broadcast signal communications; outputting, based at least in part on enablement of the multi-port downlink broadcast signal communications, a first downlink broadcast signal for a UE; and outputting, based at least in part on enablement of the multi-port downlink broadcast signal communications, a second downlink broadcast signal for the UE, wherein the first downlink broadcast signal and the second downlink broadcast signal are obtained prior to output, for the UE, of an RRC message indicative of first configuration information for the UE.

Aspect 45: The method of aspect 44, wherein the first downlink broadcast signal comprises a first paging message.

Aspect 46: The method of aspect 45, wherein the second downlink broadcast signal comprises a downlink reference signal or a second paging message.

Aspect 47: The method of any of aspects 45 through 46, wherein participating in communication of the one or more signals that enable the multi-port downlink broadcast signal communications comprises: outputting second configuration information indicative of a paging type of a PO.

Aspect 48: The method of aspect 47, wherein the paging type is indicative of multi-port paging.

Aspect 49: The method of any of aspects 47 through 48, wherein the multi-port downlink broadcast signal communications are enabled in accordance with the paging type.

Aspect 50: The method of any of aspects 45 through 49, wherein participating in communication of the one or more signals that enable the multi-port downlink broadcast signal communications comprises: outputting a control message associated with the first paging message, wherein the control message indicates a paging type of the first paging message.

Aspect 51: The method of aspect 50, wherein the paging type is indicative of multi-port paging.

Aspect 52: The method of any of aspects 50 through 51, wherein the multi-port downlink broadcast signal communications are enabled in accordance with the paging type.

Aspect 53: The method of any of aspects 45 through 52, wherein participating in communication of the one or more signals that enable the multi-port downlink broadcast signal communications comprises: outputting a PEI for the first paging message, wherein the PEI indicates a paging type of the first paging message.

Aspect 54: The method of aspect 53, wherein the paging type is indicative of multi-port paging.

Aspect 55: The method of any of aspects 53 through 54, wherein the multi-port downlink broadcast signal communications are enabled in accordance with the paging type.

Aspect 56: The method of any of aspects 45 through 55, wherein multi-rank uplink communications are enabled during a RA procedure in accordance with enablement of the multi-port downlink broadcast signal communications and based at least in part on the second downlink broadcast signal comprising a downlink reference signal.

Aspect 57: The method of any of aspects 45 through 56, wherein the first paging message is associated with one or more first symbols in a downlink control channel and one or more second symbols in a downlink shared channel.

Aspect 58: The method of aspect 57, wherein the first paging message is output via the one or more first symbols in the downlink control channel.

Aspect 59: The method of any of aspects 57 through 58, wherein the second downlink broadcast signal comprises a downlink reference signal output via the one or more second symbols in the downlink shared channel.

Aspect 60: The method of any of aspects 45 through 59, wherein the first paging message comprises a first portion of a paging data message.

Aspect 61: The method of aspect 60, wherein the second downlink broadcast signal comprises a second paging message that further comprises a second portion of the paging data message.

Aspect 62: The method of any of aspects 44 through 61, wherein the first downlink broadcast signal comprises a first SIB message.

Aspect 63: The method of aspect 62, wherein the second downlink broadcast signal comprises a second SIB message or a downlink reference signal.

Aspect 64: The method of any of aspects 62 through 63, wherein participating in communication of the one or more signals that enable the multi-port downlink broadcast signal communications comprises: outputting configuration information that indicates on-demand SIB messages are associated with multi-port communications and indicates periodic SIB messages are associated with single-port communications.

Aspect 65: The method of aspect 64, wherein the first SIB message is a first on-demand SIB message.

Aspect 66: The method of aspect 65, wherein the first downlink broadcast signal and the second downlink broadcast signal are received via different ports in accordance with the first on-demand SIB message.

Aspect 67: The method of any of aspects 62 through 66, wherein participating in communication of the one or more signals that enable the multi-port downlink broadcast signal communications comprises: outputting a control message that schedules the first SIB message, wherein the control message indicates a SIB transmission type of the first SIB message.

Aspect 68: The method of aspect 67, wherein the SIB transmission type is indicative of multi-port communications.

Aspect 69: The method of any of aspects 67 through 68, wherein the multi-port downlink broadcast signal communications are enabled in accordance with the SIB transmission type.

Aspect 70: The method of any of aspects 62 through 69, wherein participating in communication of the one or more signals that enable the multi-port downlink broadcast signal communications comprises: obtaining a request message indicative of a SIB transmission type for the first SIB message.

Aspect 71: The method of aspect 70, wherein the requested SIB transmission type is indicative of multi-port communications.

Aspect 72: The method of any of aspects 70 through 71, wherein the multi-port downlink broadcast signal communications are enabled in accordance with the requested SIB transmission type.

Aspect 73: The method of any of aspects 70 through 72, wherein the request message comprises an uplink WUS.

Aspect 74: The method of any of aspects 62 through 73, wherein the first SIB message comprises control information, and the second downlink broadcast signal comprises a second SIB message that further comprises data associated with the first SIB message.

Aspect 75: The method of any of aspects 44 through 74, wherein the first downlink broadcast signal comprises a downlink message of a RA procedure.

Aspect 76: The method of aspect 75, wherein the second downlink broadcast signal comprises a downlink reference signal or a downlink data message associated with the downlink message of the RA procedure.

Aspect 77: The method of any of aspects 75 through 76, wherein the downlink message comprises a first downlink message of the RA procedure, and wherein participating in communication of the one or more signals that enable the multi-port downlink broadcast signal communications comprises: obtaining a first uplink message of the RA procedure via a first set of resources.

Aspect 78: The method of aspect 77, wherein the first set of resources corresponds to a first type of RA procedure from a plurality of types of RA procedures.

Aspect 79: The method of aspect 78, wherein the first type of RA procedure enables multi-port transmissions.

Aspect 80: The method of aspect 79, wherein the multi-port downlink broadcast signal communications are enabled in accordance with the first type of RA procedure.

Aspect 81: The method of any of aspects 75 through 80, wherein the downlink message comprises a first downlink message of the RA procedure, and wherein participating in communication of the one or more signals that enable the multi-port downlink broadcast signal communications comprises: outputting a control message associated with the first downlink message of the RA procedure, wherein the control message indicates a transmission type of the first downlink message of the RA procedure.

Aspect 82: The method of aspect 81, wherein the transmission type is indicative of multi-port communications.

Aspect 83: The method of any of aspects 81 through 82, wherein the multi-port downlink broadcast signal communications are enabled in accordance with the transmission type.

Aspect 84: The method of any of aspects 75 through 83, wherein the downlink message comprises a first downlink message of the RA procedure, the method further comprising: obtaining, via a second uplink message of the RA procedure, a report indicative of a rank indicator, a PMI, or both, in response to enablement of the multi-port downlink broadcast signal communications.

Aspect 85: The method of any of aspects 75 through 84, wherein the downlink message comprises a second downlink message of the RA procedure, the method further comprising: obtain, via a feedback message in response to the second downlink message of the RA procedure or via another uplink message, a report indicative of a rank indicator, a PMI, or both, in response to enablement of the multi-port downlink broadcast signal communications.

Aspect 86: The method of any of aspects 44 through 85, wherein the first downlink broadcast signal comprises a DMRS, and the second downlink broadcast signal comprises another downlink reference signal.

Aspect 87: The method of aspect 86, wherein the DMRS and the downlink reference signal are outputted via a same set of resources in a time domain or a same set of resources in a frequency domain.

Aspect 88: The method of any of aspects 86 through 87, wherein the DMRS is associated with a first power offset relative to a SSB.

Aspect 89: The method of aspect 88, wherein the downlink reference signal is associated with a second power offset relative to the SSB, the second power offset different from the first power offset.

Aspect 90: An apparatus for wireless communication at a UE, comprising one or more memories and one or more processors coupled with the one or more memories, the one or more processors configured to cause the UE to perform a method of any of aspects 1 through 43.

Aspect 91: The apparatus of aspect 90, further comprising: one or more antennas configured to receive the first downlink broadcast signal via the first port and to receive the second downlink broadcast signal via the second port.

Aspect 92: An apparatus for wireless communication at a UE, comprising at least one means for performing a method of any of aspects 1 through 43.

Aspect 93: A non-transitory computer-readable medium storing code for wireless communication, the code comprising instructions executable by one or more processors to perform a method of any of aspects 1 through 43.

Aspect 94: An apparatus for wireless communication at a network entity, comprising one or more memories and one or more processors coupled with the one or more memories, the one or more processors configured to cause the network entity to perform a method of any of aspects 44 through 89.

Aspect 95: The apparatus of aspect 94, further comprising: one or more antennas configured to output the first downlink broadcast signal and the second downlink broadcast signal.

Aspect 96: An apparatus for wireless communication at a network entity, comprising at least one means for performing a method of any of aspects 44 through 89.

Aspect 97: A non-transitory computer-readable medium storing code for wireless communications, the code comprising instructions executable by one or more processors to perform a method of any of aspects 44 through 89.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled with the one or more memories and configured to cause the UE to:
participate in communication of one or more signals that enable multi-port downlink broadcast signal communications;
receive, via a first port of a plurality of ports of the UE and based at least in part on enablement of the multi-port downlink broadcast signal communications, a first downlink broadcast signal from a network entity; and
receive, via a second port of the plurality of ports and based at least in part on enablement of the multi-port downlink broadcast signal communications, a second downlink broadcast signal from the network entity, wherein the first port is different from the second port, and wherein the first downlink broadcast signal and the second downlink broadcast signal are received prior to reception, from the network entity, of a radio resource control message that indicates first configuration information for the UE.

2. The apparatus of claim 1, wherein the first downlink broadcast signal comprises a first paging message, and wherein the second downlink broadcast signal comprises a downlink reference signal or a second paging message.

3. The apparatus of claim 2, wherein, to participate in communication of the one or more signals that enable the multi-port downlink broadcast signal communications, the one or more processors are configured to cause the UE to:
receive second configuration information indicative of a paging type of a paging occasion, wherein the paging type is indicative of multi-port paging, wherein the first downlink broadcast signal and the second downlink broadcast signal are received via different ports during the paging occasion in accordance with the paging type.

4. The apparatus of claim 2, wherein, to participate in communication of the one or more signals that enable the multi-port downlink broadcast signal communications, the one or more processors are configured to cause the UE to:
receive a control message associated with the first paging message, wherein the control message indicates a paging type of the first paging message, wherein the paging type is indicative of multi-port paging, and wherein the first downlink broadcast signal and the second downlink broadcast signal are received via different ports in accordance with the paging type.

5. The apparatus of claim 2, wherein, to participate in communication of the one or more signals that enable the multi-port downlink broadcast signal communications, the one or more processors are configured to cause the UE to:
receive a paging early indication for the first paging message, wherein the paging early indication indicates a paging type of the first paging message, wherein the paging type is indicative of multi-port paging, and wherein the first downlink broadcast signal and the second downlink broadcast signal are received via different ports in accordance with the paging type.

6. The apparatus of claim 2, wherein multi-rank uplink transmissions are enabled during a random access procedure in accordance with enablement of the multi-port downlink broadcast signal communications and based at least in part on the second downlink broadcast signal comprising the downlink reference signal.

7. The apparatus of claim 2, wherein the first paging message is associated with one or more first symbols in a downlink control channel and one or more second symbols in a downlink shared channel, wherein the first paging message is received via the one or more first symbols in the downlink control channel, and wherein the second downlink broadcast signal comprises the downlink reference signal received via the one or more second symbols in the downlink shared channel.

8. The apparatus of claim 2, wherein the first paging message comprises a first portion of a paging data message, and wherein the second downlink broadcast signal comprises the second paging message that further comprises a second portion of the paging data message.

9. The apparatus of claim 1, wherein the first downlink broadcast signal comprises a first system information block (SIB) message, and wherein the second downlink broadcast signal comprises a second SIB message or a downlink reference signal.

10. The apparatus of claim 9, wherein, to communicate the one or more signals that enable the multi-port downlink broadcast signal communications, the one or more processors are configured to cause the UE to:
receive configuration information that indicates on-demand SIB messages are associated with multi-port communications and indicates periodic SIB messages are associated with single-port communications, wherein the first SIB message is a first on-demand SIB message, and wherein the first downlink broadcast signal and the second downlink broadcast signal are received via different ports in accordance with the first on-demand SIB message.

11. The apparatus of claim 9, wherein, to participate in communication of the one or more signals that enable the multi-port downlink broadcast signal communications, the one or more processors are configured to cause the UE to:
receive a control message that schedules the first SIB message, wherein the control message indicates a SIB transmission type of the first SIB message, wherein the SIB transmission type is indicative of multi-port communications, and wherein the first downlink broadcast signal and the second downlink broadcast signal are received via different ports in accordance with the SIB transmission type.

12. The apparatus of claim 9, wherein, to participate in communication of the one or more signals that enable the multi-port downlink broadcast signal communications, the one or more processors are configured to cause the UE to:
transmit a request message indicative of a SIB transmission type for the first SIB message, wherein the requested SIB transmission type is indicative of multi-port communications, and wherein the first downlink broadcast signal and the second downlink broadcast signal are received via different ports in accordance with the requested SIB transmission type.

13. The apparatus of claim 1, wherein the first downlink broadcast signal comprises a downlink message of a random access procedure, wherein the second downlink broadcast signal comprises a downlink reference signal or a downlink data message associated with the downlink message of the random access procedure.

14. The apparatus of claim 13, wherein the downlink message comprises a first downlink message of the random access procedure, and wherein, to participate in communication of the one or more signals that enable the multi-port downlink broadcast signal communications, the one or more processors are configured to cause the UE to:
transmit a first uplink message of the random access procedure via a first set of resources, wherein the first set of resources corresponds to a first type of random access procedure from a plurality of types of random access procedures, wherein the first type of random access procedure enables multi-port transmissions, and wherein the first downlink message of the random access procedure and the second downlink broadcast signal are received via different ports in accordance with enablement of multi-port communications based at least in part on the first type of random access procedure.

15. The apparatus of claim 13, wherein the downlink message comprises a first downlink message of the random access procedure, and wherein, to participate in communication of the one or more signals that enable the multi-port downlink broadcast signal communications, the one or more processors are configured to cause the UE to:
receive a control message associated with the first downlink message of the random access procedure, wherein the control message indicates a transmission type of the first downlink message of the random access procedure, wherein the transmission type is indicative of multi-port communications, and wherein the first downlink message of the random access procedure and the second downlink broadcast signal are received via different ports in accordance with the transmission type.

16. The apparatus of claim 1, wherein the first downlink broadcast signal comprises a demodulation reference signal, and wherein the second downlink broadcast signal comprises another downlink reference signal.

17. The apparatus of claim 16, wherein the demodulation reference signal is associated with a first power offset relative to a synchronization signal block, wherein the downlink reference signal is associated with a second power offset relative to the synchronization signal block, the second power offset different from the first power offset.

18. The apparatus of claim 16, further comprising:
one or more antennas configured to receive the first downlink broadcast signal via the first port and to receive the second downlink broadcast signal via the second port.

19. An apparatus for wireless communications at a network entity, comprising:
one or more memories; and
one or more processors coupled with the one or more memories and configured to cause the network entity to:
participate in communication of one or more signals that enable multi-port downlink broadcast signal communications;
output, based at least in part on enablement of the multi-port downlink broadcast signal communications, a first downlink broadcast signal for a user equipment (UE); and
output, based at least in part on enablement of the multi-port downlink broadcast signal communications, a second downlink broadcast signal for the UE, wherein the first downlink broadcast signal and the second downlink broadcast signal are output prior to output, for the UE, of a radio resource control message indicative of first configuration information for the UE.

20. A method for wireless communication at a user equipment (UE), comprising:
participating in communication of one or more signals that enable multi-port downlink broadcast signal communications;
receiving, via a first port of a plurality of ports of the UE and based at least in part on enablement of the multi-port downlink broadcast signal communications, a first downlink broadcast signal from a network entity; and
receiving, via a second port of the plurality of ports and based at least in part on enablement of the multi-port downlink broadcast signal communications, a second downlink broadcast signal from the network entity, wherein the first port is different from the second port, and wherein the first downlink broadcast signal and the second downlink broadcast signal are received prior to reception, from the network entity, of a radio resource control message that indicates first configuration information for the UE.
